(19) United States
(12) Patent Application Publication
(10) Pub. No.: US 2013/0303383 A1
(43) Pub. Date: Nov. 14, 2013

(54) METHODS AND APPARATUS FOR PREDICTING PROTEIN STRUCTURE

(71) Applicants: Sloan-Kettering Institute for Cancer Reseach, (US); President and Fellows of Harvard College, (US)

(72) Inventors: Chris Sander, New York, MA (US); Debora S. Marks, Brookline, MA (US)

(21) Appl. No.: 13/891,066

(22) Filed: May 9, 2013

Related U.S. Application Data
(63) Continuation-in-part of application No. 13/682,703, filed on Nov. 20, 2012.
(60) Provisional application No. 61/645,027, filed on May 9, 2012.
(60) Provisional application No. 61/645,564, filed on May 10, 2012.

(51) Int. Cl. G06F 19/12

(52) U.S. Cl. CPC G06F 19/12
USPC 506/2; 703/2

(57) ABSTRACT

The present invention relates to a method for predicting three-dimensional structure of a protein from its sequence. Three-dimensional structure may be determined by: (a) generating a multiple sequence alignment for a candidate protein having a known sequence; (b) identifying a covariance matrix between all pairs of sequence positions in the multiple sequence alignment; (c) inverting the covariance matrix and identifying predicted evolutionary constraints using a statistical model of the candidate protein; and (d) simulating folding of an extended chain structure of the candidate protein using the predicted constraints.

### CROSS REFERENCE TO RELATED APPLICATIONS

This application claims the benefit of U.S. application Ser. No. 13/682,703, filed Nov. 20, 2012, of U.S. Provisional Application No. 61/645,027, filed May 9, 2012, and of U.S. Provisional Application No. 61/645,564, filed May 10, 2012, the contents of all of which are hereby incorporated by reference herein in their entireties.

### BACKGROUND

Many transmembrane proteins facilitate transport of substances across the biological membrane or function as receptors and are important in the performance of various biological functions. Identifying the 3D structure of such transmembrane proteins is useful, for example, in the pharmacological selection or design of drugs for the treatment of various diseases and disorders. Knowing the 3D structure of such proteins is also important, for example, in the identification of functional genetic variants in normal and disease genomes. However, it is difficult to investigate the 3D structure of proteins that are anchored in biomembranes using standard biochemical methods, even where the sequence of the protein is known.

Computational methods have been developed in an effort to predict 3D structure of proteins. Work in this space includes Alan Lapedes et al., “Using sequence alignments to predict protein structure and stability with high accuracy,” Los Alamos National Laboratory, LA-UR-02-4481, reprinted July 2012, Cornell University Library arXiv.org; Weigt M., et al. (2009) “Identification of direct residue contacts in protein-protein interaction by message passing,” Proc Natl Acad Sci 106: 67-72; “Morcos et al. (2011) Direct-coupling analysis of residue coevolution captures native contacts across many protein families,” PNAS Vol. 108, No. 49, E1293-E1301; and Ekeberg et al. (2013), “Improved contact prediction in proteins: Using pseudolikelihoods to infer Potts models,” Physical Review E 87, 012707.

Previous methods of structure prediction, for example, energy minimization and database fragment searches, are limited in accuracy and the size of the protein whose structure can be predicted. Thus, there is a need for more accurate methods for predicting the 3D structure of a protein from its sequence, particularly for transmembrane proteins.

### SUMMARY OF THE INVENTION

It has been found that correlations between residues can be used to predict structural proximity and functional features of proteins. A maximum entropy model of the protein sequence, constrained by the statistics of multiple sequence alignment, can be used to infer residue pair couplings. Surprisingly, it has been found that the strength of these inferred couplings is an excellent predictor of residue-residue proximity in folded structures, and the top-scoring residue couplings are sufficiently accurate and well-distributed to define 3D protein folds with high accuracy. Methods are presented herein that further identify conformational or shape changes of proteins, e.g., identifying 3D structure transitions.

Demonstrated herein is the ability of the methods to predict 3D protein structures from sequence information and to identify functional sites from predicted evolutionary constraints in known and previously unknown structures. The method can also be used to predict the three-dimensional structures of multidomain proteins and protein complexes.

In one aspect, the invention features a method of predicting structure of a polypeptide. In some embodiments, a method of the invention includes steps of: (a) generating a multiple sequence alignment for an amino acid sequence of a polypeptide; (b) identifying evolutionary constraints for the polypeptide from the multiple sequence alignment using a statistical analysis; and (c) simulating folding of an extended chain structure of the polypeptide using the identified constraints, thereby predicting one or more structures corresponding to the polypeptide. In some embodiments, the statistical analysis in step (b) is a pseudolikelihood maximization analysis. In some embodiments, the statistical analysis in step (b) is an entropy maximization analysis.

In some embodiments, the method further comprises comparing the predicted structure of the polypeptide with a known structure of the polypeptide, wherein identified evolutionary constraints that are inconsistent with the known structure are indicative that the polypeptide forms a dimer with a second polypeptide. In some embodiments, the method further comprises providing a structure of the second polypeptide.

In some embodiments, the method further comprises simulating folding of the polypeptide and the second polypeptide into a dimer using the identified inconsistent evolutionary constraints as distance constraints between the polypeptide and the second polypeptide. In some embodiments, the first and second polypeptide are identical, and the dimer is a homodimer. In some embodiments, the first and second polypeptide differ from each other, and the dimer is a heterodimer.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of identifying an interaction partner of a target polypeptide. In some embodiments, the method comprises: (a) providing a target polypeptide structure for a target polypeptide predicted by a method comprising: (i) generating a multiple sequence alignment for an amino acid sequence of the target polypeptide; (ii) identifying evolutionary constraints for the target polypeptide from the multiple sequence alignment using a statistical analysis; and (iii) simulating folding of an extended chain structure of the target polypeptide using the identified constraints, thereby predicting a structure corresponding to the target polypeptide; (b) for each of a plurality of candidate interaction partners, docking in silico the predicted structure of the target polypeptide with a known or predicted structure of the candidate interaction partner, thereby determining a score associated with the candidate interaction partner; and (c) identifying one or more of the candidate interaction partners whose score satisfies a predetermined criterion as an interaction partner of the target polypeptide.

In some embodiments, the statistical analysis in step (ii) is a pseudolikelihood maximization analysis. In some embodiments, the statistical analysis in step (ii) is an entropy maximization analysis.

In some embodiments, the interaction partner is a binding partner. In some embodiments, the score is a free energy score.

In some embodiments, the candidate interaction partner is or comprises a small molecule. In some embodiments, the candidate interaction partner is or comprises a polypeptide.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of selecting an amino acid sequence. In some embodiments, the method comprises providing a target three-dimensional polypeptide structure; providing an initial amino acid sequence; determining a structure of the initial amino acid sequence by: (i) generating a multiple sequence alignment for the initial amino acid sequence; (ii) identifying evolutionary constraints for the initial amino acid sequence from the multiple sequence alignment using a statistical analysis; and (iii) simulating folding of an extended chain structure of the initial amino acid sequence using the identified constraints, thereby determining a structure corresponding to the initial amino acid sequence; selecting the initial amino acid sequence if the target polypeptide structure and structure of the initial amino acid sequence are sufficiently similar.

In some embodiments, the statistical analysis in step (ii) is a pseudolikelihood maximization analysis. In some embodiments, the statistical analysis in step (ii) is an entropy maximization analysis.

In some embodiments, the target three-dimensional structure is a full three-dimensional structure. In some embodiments, the target three-dimensional structure is a set of 3D structure attributes. In some embodiments, the target three-dimensional structure includes alpha helices and/or beta sheets.

In some embodiments, the method further comprises modifying the initial amino acid sequence; and determining a structure of the modified amino acid sequence by steps (i) to (iii). In some embodiments, the modifying step is repeated until the target polypeptide structure and the modified amino acid sequence structure are sufficiently similar.

In some embodiments, the amino acid sequence is selected if the target polypeptide structure and structure of the amino acid sequence meet a predetermined matching criterion. In some embodiments, the predetermined matching criterion is about 50%, 60%, 70%, 80%, 90%, 95%, or 100% alignment of amino acid residues.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of designing a modified polypeptide. In some embodiments, the method comprises providing a target structure of an amino acid sequence determined by: (i) generating a multiple sequence alignment for the amino acid sequence; (ii) identifying evolutionary constraints for the amino acid sequence from the multiple sequence alignment using a statistical analysis; and (iii) simulating folding of an extended chain structure of the amino acid sequence using the identified constraints, thereby determining a target structure corresponding to the amino acid sequence; and identifying in the provided target structure at least one site for modification.

In some embodiments, the statistical analysis in step (ii) is a pseudolikelihood maximization analysis. In some embodiments, the statistical analysis in step (ii) is an entropy maximization analysis.

In some embodiments, the target three-dimensional structure is a full three-dimensional structure. In some embodiments, the target three-dimensional structure is a set of 3D structure attributes. In some embodiments, the target three-dimensional structure includes alpha helices and/or beta sheets.

In some embodiments, the method further comprises identifying at least a portion of the amino acid sequence corresponding to the at least one site identified for modification.

In some embodiments, the method further comprises modifying the identified portion of the amino acid sequence and determining a structure of the modified amino acid sequence. In some embodiments, the amino acid sequence is modified by one or more of a substitution, deletion, or insertion of one or more amino acids within the identified portion.

In some embodiments, the at least one site for modification is identified by docking in silico the provided target structure with a known or predicted structure of a candidate interaction partner. In some embodiments, the method further comprises docking in silico the modified amino acid structure with the structure of the candidate interaction partner and determining whether the modification affects affinity or specificity of an interaction of the candidate interaction partner and the target structure.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of designing an amino acid sequence. In some embodiments, the method comprises determining a set of structural arrangement characteristics; providing a plurality of amino acid sequences; for each of the plurality of amino acid sequences: (i) generating a multiple sequence alignment for the amino acid sequence; (ii) identifying evolutionary constraints for the amino acid sequence from the multiple sequence alignment using a statistical analysis; and (iii) simulating folding of an extended chain structure of the amino acid sequence using the identified constraints, thereby determining a structure corresponding to the amino acid sequence; and selecting a set of amino acid sequences from the plurality that, taken together, achieve the determined set of structural arrangement characteristics, thereby designing an amino acid sequence.

In some embodiments, the statistical analysis in step (ii) is a pseudolikelihood maximization analysis. In some embodiments, the statistical analysis in step (ii) is an entropy maximization analysis.

In some embodiments, the target three-dimensional structure is a full three-dimensional structure. In some embodiments, the target three-dimensional structure is a set of 3D structure attributes. In some embodiments, the target three-dimensional structure includes alpha helices and/or beta sheets.

In some embodiments, the method further comprises assigning a linear order to the selected set of amino acid sequences such that, when folded in three dimensional space, achieves the determined set of structural arrangement characteristics, thereby producing a linear amino acid sequence.

In some embodiments, the plurality of amino acid sequences is provided in a library. In some embodiments, the plurality of amino acid sequences is provided in a phage display library.

In some embodiments, the method further comprises producing a polypeptide encoded by the linear amino acid sequence.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of determining a structure of a polypeptide. In some embodiments, the method comprises: (a) generating a multiple sequence alignment for an amino acid sequence of a polypeptide; (b) identifying evolutionary constraints for the polypeptide from the multiple sequence alignment using a statistical analysis; (c) performing X-ray crystallography and/or NMR experiments on a sample of the polypeptide, thereby identifying one or more experimentally-determined structural constraints for the polypeptide; and (d) using the identified evolutionary constraints in step (b) and the experimentally-determined structural constraints in step (c) to determine the structure of the polypeptide.

In some embodiments, the statistical analysis in step (b) is a pseudolikelihood maximization analysis. In some embodiments, the statistical analysis in step (b) is an entropy maximization analysis.

In some embodiments, the one or more identified experimentally-determined structural constraints for the polypeptide are or comprise distance constraints.

In some embodiments, the method further comprises using the identified evolutionary constraints identified in step (c) to design the X-ray crystallography and/or NMR experiments performed in step (d) to identify the one or more experimentally-determined structural constraints for the polypeptide.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of predicting structure of a multi-domain polypeptide, the method comprising the steps of: (a) generating a first multiple sequence alignment for an amino acid sequence of a first domain of a multi-domain polypeptide; (b) generating a second multiple sequence alignment for an amino acid sequence of a second domain of the polypeptide; (c) identifying evolutionary constraints (e.g., inter-domain couplings) for the first and second domains from the first and second multiple sequence alignments using a statistical analysis; and (d) simulating folding of extended chain structures of the first and second domains using the identified evolutionary constraints, thereby predicting one or more structures corresponding to the multi-domain polypeptide.

In some embodiments, the statistical analysis in step (c) is a pseudolikelihood maximization analysis. In some embodiments, the statistical analysis in step (c) is an entropy maximization analysis.

In some embodiments, the method further comprises evaluating evolutionary depth, sequence diversity, and/or subfamily structure within each of the first multiple sequence alignment and the second multiple sequence alignment. In some embodiments, the method further comprises identifying the evolutionary constraints with calibration of cutoff. In some embodiments, the method further comprises identifying weighted distance constraints (e.g., using Haddock/CNS). In some embodiments, the method further comprises identifying all-atom coordinates of the multi-domain polypeptide. In some embodiments, the method further comprises evaluating prediction accuracy.

Features of the embodiments described with respect to the above aspect of the invention may be used with other aspects of the invention, described herein. Likewise, features of the embodiments described with respect to other aspects of the invention described herein may be used with respect to the above aspect of the invention.

In another aspect, the invention features a method of predicting structure of a polypeptide complex, the method comprising the steps of: (a) providing an amino acid sequence for each polypeptide of a polypeptide complex; (b) generating a multiple sequence alignment for each polypeptide, including a first multiple sequence alignment for a first polypeptide and a second multiple sequence alignment for a second polypeptide; (c) identifying evolutionary constraints (e.g., inter-polypeptide couplings) from at least the first and the second multiple sequence alignments using a statistical analysis; and (d) simulating folding of extended chain structures of the polypeptides using the identified evolutionary constraints, thereby predicting one or more structures corresponding to the polypeptide complex.

In some embodiments, the statistical analysis in step (c) is a pseudolikelihood maximization analysis. In some embodiments, the statistical analysis in step (c) is an entropy maximization analysis.

In some embodiments, the method further comprises evaluating evolutionary depth, sequence diversity, and/or subfamily structure within each of the first multiple sequence alignment and the second multiple sequence alignment. In some embodiments, the method further comprises identifying the evolutionary constraints with calibration of cutoff. In some embodiments, the method further comprises identifying weighted distance constraints (e.g., using Haddock/CNS). In some embodiments, the method further comprises identifying all-atom coordinates of the polypeptide complex. In some embodiments, the method further comprises evaluating prediction accuracy.

Features of the embodiments described with respect to the above aspect of the invention may be used with other aspects of the invention, described herein. Likewise, features of the embodiments described with respect to other aspects of the invention described herein may be used with respect to the above aspect of the invention.

In any of the aspects described herein, a method can include a step of identifying multiple structures of a candidate protein. In any of the aspects described herein, a method of the invention further includes using one or more predicted structures to identify active sites and/or binding sites, for example, via docking calculations, and/or constructing or determining a candidate drug using identified active sites and/or binding sites.

In any of the aspects described herein, a polypeptide is a transmembrane protein. In some embodiments, the method comprises identifying evolutionary constraints corresponding to residue pairs predicted to be close in 3D space, and eliminating evolutionary constraints for which 3D proximity is unlikely due to presence of a membrane. In some embodiments, the structure is a structure of the entire protein.

In any of the aspects described herein, methods of the invention can include synthesizing a candidate drug or interaction partner, e.g., identified using a method described herein.

In any of the aspects described herein, methods of the invention further can comprise synthesizing a polypeptide, wherein the polypeptide has a structure predicted using a method of the invention.

In any of the aspects described herein, a polypeptide (e.g., a polypeptide whose structure is determined using a disclosed method) can be a cytosolic, extracellular, membrane associated, or membrane bound polypeptide. In some embodiments, the polypeptide is a transmembrane protein, e.g., a transmembrane protein comprising an α-helical chain. In some embodiments, the polypeptide is a G protein-coupled receptor (GPCR). In some embodiments, the polypeptide comprises 1, 2, 3, 4, 5, 6, 7, 8, 9, 10, 11, 12, 13, 14, 15, or more transmembrane helices.

In any of the aspects described herein, methods can further comprise ranking predicted structures, e.g., using a quality measure of backbone alpha torsion and/or beta sheet twist.

In any of the aspects described herein, methods can be computed implemented (e.g., partially or completely).

In any of the aspects described herein, methods can include simulating folding of an extended chain structure of a polypeptide using identified constraints. In some embodiments, simulating folding includes identifying residue-residue distance constraints corresponding to the identified evolutionary constraints; and generating three-dimensional coordinates corresponding to the identified residue-residue distance constraints using a distance geometry algorithm. In some embodiments, simulating folding includes refining three-dimensional coordinates by performing simulated annealing to determine a plurality of predicted structures. In some embodiments, the predicted structures are ranked.

In another aspect, the invention features an apparatus for predicting structure of a polypeptide, the apparatus comprising: a memory for storing a code defining a set of instructions; and a processor for executing the set of instructions, wherein the code comprises an analysis module configured to: (a) generate a multiple sequence alignment for an amino acid sequence of a polypeptide; (b) identify evolutionary constraints from the multiple sequence alignment using a statistical analysis; and (c) simulate folding of an extended chain structure of the polypeptide using the identified constraints, thereby predicting one or more structures corresponding to the polypeptide.

In some embodiments, the polypeptide is a transmembrane protein and wherein the analysis module is configured to identify evolutionary constraints corresponding to residue pairs predicted to be close in 3D space, and eliminate evolutionary constraints for which 3D proximity is unlikely due to presence of a membrane. In some embodiments, the structure is a structure of the entire protein. In some embodiments, the statistical analysis is a pseudolikelihood maximization analysis. In some embodiments, the statistical analysis is an entropy maximization analysis. In some embodiments, the analysis module is configured to identify multiple 3D conformations of the polypeptide. In some embodiments, the analysis module is further configured to identify one or more active sites, one or more binding sites, or one or more active sites and binding sites via docking calculations using the one or more predicted structures, and construct or determine a candidate drug using the identified active sites or binding sites. In some embodiments, the polypeptide is a transmembrane protein comprising an α-helical chain. In some embodiments, the protein is a G protein-coupled receptor (GPCR). In some embodiments, the protein has greater than 7 transmembrane helices. In some embodiments, the analysis module is configured to rank the predicted one or more structures using a quality measure of backbone alpha torsion and/or beta sheet twist.

In other aspects of the invention corresponding to methods described herein, the invention features an apparatus for performing the method, the apparatus comprising: a memory for storing a code defining a set of instructions; and a processor for executing the set of instructions, wherein the code comprises an analysis module configured to perform steps of the method.

In other aspects of the invention corresponding to methods described herein, the invention features a processor; and a non-transitory computer readable medium storing instructions thereon wherein the instructions, when executed, cause the processor to perform steps of the method.

In other aspects of the invention corresponding to the methods described herein, the invention features a non-transitory computer readable medium storing a set of instructions that, when executed by a processor, cause the processor to perform steps of the method.

### BRIEF DESCRIPTION OF THE DRAWING

The foregoing and other objects, aspects, features, and advantages of the invention will become more apparent and may be better understood by referring to the following description taken in conjunction with the accompanying drawings, in which:

FIGS. 1A and 1B are schematics of exemplary methods of predicting protein structure from a sequence.

FIG. 2 is an exemplary apparatus for according to an illustrative embodiment of the invention for predicting 3D structure of a protein from its sequence.

FIG. 3 is a schematic illustration showing evolutionary couplings as calculated by EVfold; membrane placed as distance constraints on extended polypeptide before folding. Top-ranked models of a representative set of six transmembrane proteins from diverse families, which have no members with known 3D structures. Models are cartoon representations seen from the side (left) and noncytoplasmic side (right). Naming conventions, 3D coordinates, and input files in are shown in Table 1.

FIG. 4A are histograms depicting building alignments for the EC calculation for the specific query protein illustrating a trade-off between specificity and diversity. To investigate this blindly, a range of alignment depths using different expectation values are scanned and the effective number of sequences returned (diversity) and the number of residues in our query protein sequence that do not have more than 30% gaps in the alignment column of the alignment (coverage) are calculated. Dashed arrows point to chosen stringency for folding. Contrast in the distribution of sequence space at different alignment depths in histograms of the range of number of sequences with the 0%-100% identity to query protein sequence (insets, middle). FIG. 4B are schematics showing constraint conflict resolution between predicted coevolution and predicted secondary structure/membrane topology. In all cases the predicted membrane topology is followed and coevolving residue pairs that conflict with this prediction are discarded. The predicted toy contact map (middle) shows evolutionary constraints that conflict with the predicted membrane topology that are removed (dark stars). Evolutionary constraints that do not conflict with the predicted membrane topology are not removed, irrespective of any knowledge about their distance in 3D space (constraint 1). FIG. 4C depicts a comparison of the top-ranked model from the set of each de novo predicted structure to the entire PDB using the structural alignment program DALI. Three of the six predicted 3D transmembrane protein structures with significant structural similarities to known transmembrane protein folds are shown.

FIG. 5A are structural superpositions of predicted structures (dark) onto experimental structures (gray). First panel for each protein: side view from within the membrane; second panel: top-down view from noncytoplasmic side. All figures were rendered with PyMOL. FIG. 5B is a graph depicting accuracy of 3D structure prediction for candidates with known structure. Template modeling score (TM score) of the best model for each protein plotted against the number of sequences in the multiple sequence alignment, normalized by modeled protein length. FIG. 5C are graphs depicting surprising stability of 3D prediction accuracy as the true positive rate of evolutionary constraints decreases, going down the list of ranked ECs. The TM score of the best prediction (dark solid line) and the true positive rate (light lines) are plotted for increasing numbers of evolutionary constraints (divided by the number of residues in the protein to allow comparison between proteins). Distance cut-offs to define true contacts of true positive rate are 5 Å (dotted line), 7 Å (dashed line), and 8 Å (light line).

FIG. 6 are graphs of ranks of evolutionary constraints (ECs), derived from the strength of pairwise couplings, plotted against the minimum 3D distance in A between any atom pair of the corresponding crystal structure residues. ECs passing the topology- and secondary structure-based filtering steps are depicted by light dots, filtered ECs by black dots. ECs which involve residues missing in the crystal structure are assigned a distance of 0 Å.

FIG. 7 depicts contact maps of top-ranked predicted ECs (stars in A and B) overlaid on crystal structure contacts (gray, known only in A). Residue pairs coevolving due to intermonomer contacts in the homo-oligomer (black circles) in an overlay of top-ranked predicted evolutionary constraints (light) experimental structure contacts (gray), where known, on contact maps for each protein. In the monomer, the corresponding residue pairs would be false positive contacts but would be true positives in the homo-oligomer structure. FIG. 7A depicts four examples of inference of oligomer contacts from ECs of known 3D structures. FIG. 7B depicts predicted dimer contacts of AdipoR1, shown on predicted monomer structures. EC pairs (black circles) at a large distance in monomer structure (about 23 Å) are close in predicted dimers. Predicted dimer cartoon (right) is a rough estimate, produced by manual-visual docking of monomers, satisfying the majority of predicted dimer interface EC pairs (middle).

FIG. 8A (Center) depicts a contact map for E. coli GlpT, residues less than 5 Å apart in the crystal structure (gray circles, PDB: 1pw4) overlaid with the top 350 ECs (stars). The similarity of the upper-left and lower-right quadrants reflect the similarity of the structure and sequences of the two domains. Upper-right and lower-left quadrants show the predicted interdomain contacts (all stars). Stripes in lower-left and upper-right quadrants cover interdomain contacts involving the periplasmic end of the helices/loops (strips, lower-left) and the cytoplasmic ends of the helices/loops (strips, upper-right). Predicted ECs located where stripes cross each are likely interdomain contacts (stars). FIG. 8A (right and left) illustrate refolded GlpT from extended polypeptide excluding constraints for cytoplasmic side open (right) and excluding constraints for cytoplasmic side closed (left). The schematics (right and left top) indicate contacts used (arrows) and not used (scissors) in refolding to get the two alternative conformations. Open conformation (right) is similar to crystal structure (Table 1) and is reproduced via refolding; closed conformation structure (left) is previously unknown and predicted here via refolding.

FIG. 8B shows details from the models in 8A. The two pairs of helices (H5/8 and H2/11) in the predicted models of GlpT are thought to change conformation dependent on state of substrate binding (closed at cytoplasm, left; open at cytoplasm, right). Differences in interhelical angles are driven by the alternative use of top or bottom contact pairs derived from ECs in refolding.

FIG. 8C shows predicted EC pairs of human OCTN1 determine the overall fold. Stripes in lower-left and upper-right quadrants cover the predicted periplasmic end of the helices/loops and the cytoplasmic ends of the helices/loops. Predicted evolutionary constraints located where stripes color cross each other are predicted interdomain contacts. 3D structures of alternative conformations of OCTN1 are not shown here. For predicted OCTN1 structure details, see FIG. 3 and Table 1.

FIGS. 9A and 9B are predicted models of the total evolutionary coupling score on individual residues, reflecting likely functional involvement. In FIG. 9A, the ligands carazolol in Adrb2 and retinal in OPSD were positioned in the predicted structure by globally superimposing the most accurate predicted model and the experimental structure plus ligand. In FIG. 9B, residues with high evolutionary coupling scores mapped on the predicted structures of unknown structure transmembrane proteins. FIG. 9C depicts above average accuracy of blinded prediction of atomic positions of the binding site of Adrb2 (1.6 Å Cα-rmsd over 9 residues). FIG. 9D depicts above average accuracy of blinded prediction of atomic positions of the binding site of bovine rhodopsin (1.8 Å Cα-rmsd over 10 residues). FIG. 9E depicts likely functional residues (high evolutionary coupling scores) in AdipoR1 on the predicted cytoplasmic side.

FIG. 10A is a schematic showing how evolutionary couplings can be used to determine internal protein structure and functional interactions, according to illustrative embodiments.

FIG. 10B features a pair of graphs showing a trade-off between the number of sequences aligned (e.g., depth) and alignment specificity, a proxy for functional similarity to the query sequence, according to an illustrative embodiment.

FIG. 10C are graphs showing that predicted contacts using evolutionary couplings determined according to an illustrative embodiment are more accurate than contacts predicted using the Mutual Information (MI) technique.

FIG. 10D is a schematic showing a computation technique for determining evolutionary constraints (ECs) using maximum entropy, according to an illustrative embodiment.

FIG. 11A is a schematic showing comparison of predicted to observed 3D structures for a benchmark set of globular proteins, according to an illustrative embodiment.

FIG. 11B is a listing showing prediction accuracy in a benchmark set of globular proteins and transmembrane proteins, according to an illustrative embodiment.

FIG. 11C is a schematic showing comparison of predicted to observed 3D structures for a benchmark set of transmembrane proteins, according to an illustrative embodiment.

FIG. 11D is a chart showing a template modeling score as a function of number of sequences per residue for a set of benchmark membrane proteins, according to an illustrative embodiment.

FIG. 12 is a schematic illustrating the identification of sites of oligomer formation from evolutionary couplings determined according to an illustrative embodiment.

FIG. 13A is a schematic illustrating the prediction of 3D structure from sequence information and identification of functional sites, according to an illustrative embodiment.

FIG. 13B is a schematic illustrating the prediction of multi-domain proteins and complexes according to an illustrative embodiment.

FIG. 13C is a schematic illustrating hybrid computational-experimental techniques using experimental data (e.g., NMR or X-ray crystallography data) along with computational determined ECs, according to an illustrative embodiment.

FIG. 14 is a schematic illustrating an implementation of a network environment for predicting protein structures, according to an illustrative embodiment.

FIG. 15 is a schematic of a computing device and a mobile computing device that can be used to implement the techniques described herein, according to an illustrative embodiment.

All publications, patent applications, patents, and other references mentioned herein, including GenBank database sequences, are incorporated by reference in their entirety. In case of conflict, the present specification, including definitions, will control. In addition, the materials, methods, and examples are illustrative only and not intended to be limiting. Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

Other features and advantages of the invention will be apparent from the following detailed description, and from the claims.

### DEFINITIONS

In order for the present invention to be more readily understood, certain terms are first defined below. Additional definitions for the following terms and other terms are set forth throughout the specification.

Amino acid: As used herein, the term “amino acid,” in its broadest sense, refers to any compound and/or substance that can be incorporated into a polypeptide chain. In certain embodiments, an amino acid has the general structure H₂N—C(H)(R)—COOH. In certain embodiments, an amino acid is a naturally-occurring amino acid. In certain embodiments, an amino acid is a synthetic or un-natural amino acid (e.g., α,α-disubstituted amino acids, N-alkyl amino acids); in some embodiments, an amino acid is a D-amino acid; in certain embodiments, an amino acid is an L-amino acid. “Standard amino acid” refers to any of the twenty standard amino acids commonly found in naturally occurring peptides including both L- and D-amino acids which are both incorporated in peptides in nature. “Nonstandard” or “unconventional amino acid” refers to any amino acid, other than the standard amino acids, regardless of whether it is prepared synthetically or obtained from a natural source. As used herein, “synthetic or un-natural amino acid” encompasses chemically modified amino acids, including but not limited to salts, amino acid derivatives (such as amides), and/or substitutions. Amino acids, including carboxy- and/or amino-terminal amino acids in peptides, can be modified by methylation, amidation, acetylation, and/or substitution with other chemical groups that can change the peptide's circulating half-life without adversely affecting its activity. Examples of unconventional or un-natural amino acids include, but are not limited to, citrulline, ornithine, norleucine, norvaline, 4-(E)-butenyl-4(R)-methyl-N-methylthreonine (MeBmt), N-methyl-leucine (MeLeu), aminoisobutyric acid, statine, and N-methyl-alanine (MeAla). Amino acids may participate in a disulfide bond. The term “amino acid” is used interchangeably with “amino acid residue,” and may refer to a free amino acid and/or to an amino acid residue of a peptide. It will be apparent from the context in which the term is used whether it refers to a free amino acid or a residue of a peptide.

Amino acid sequence: As used herein, the term “amino acid sequence” refers to a linear string of amino acids. In some embodiments, an amino acid sequence as provided and/or analyzed herein, is a full-length sequence of a relevant protein; in some embodiments an amino acid sequence as provided and/or analyzed herein is a portion of a full-length sequence, typically including at least about 5-10 amino acids. In some embodiments, an amino acid sequence as provided and/or analyzed herein includes at least one characteristic portion or sequence found in a relevant protein or protein family.

Approximately or about: As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Characteristic portion: As used herein, the term a “characteristic portion” of a substance, in the broadest sense, is one that shares some degree of sequence or structural identity with respect to the whole substance. In certain embodiments, a characteristic portion shares at least one functional characteristic with the intact substance. For example, in some embodiments, a “characteristic portion” of a polypeptide or protein is one that contains a continuous stretch of amino acids, or a collection of continuous stretches of amino acids, that together are characteristic of a polypeptide or protein. In some embodiments, each such continuous stretch generally contains at least 2, 5, 10, 15, 20, 50, or more amino acids. In some embodiments, such a continuous stretch includes certain residues whose position and identity are fixed; certain residues whose identity tolerates some variability (i.e., one of a few specified residues is accepted); and optionally certain residues whose identity is variable (i.e., any residue is accepted). In general, a characteristic portion of a substance (e.g., of a polypeptide or protein) is one that, in addition to the sequence and/or structural identity specified above, shares at least one functional characteristic with the relevant intact substance. In some embodiments, a characteristic portion may be biologically active.

Characteristic sequence: A “characteristic sequence” is a sequence that is found in all members of a family of polypeptides or nucleic acids, and therefore can be used by those of ordinary skill in the art to define members of the family.

Homology: As used herein, the term “homology” refers to overall relatedness between polymeric molecules, e.g., between nucleic acid molecules (e.g., DNA molecules and/or RNA molecules) and/or between polypeptide molecules. In some embodiments, polymeric molecules are considered to be “homologous” to one another if their sequences are at least 25%, 30%, 35%, 40%, 45%, 50%, 55%, 60%, 65%, 70%, 75%, 80%, 85%, 90%, 95%, or 99% identical. In some embodiments, polymeric molecules are considered to be “homologous” to one another if their sequences are at least 25%, 30%, 35%, 40%, 45%, 50%, 55%, 60%, 65%, 70%, 75%, 80%, 85%, 90%, 95%, or 99% similar.

Identity: As used herein, the term “identity” refers to overall relatedness between polymeric molecules, e.g., between nucleic acid molecules (e.g., DNA molecules and/or RNA molecules) and/or between polypeptide molecules. Calculation of the percent identity of two amino acid sequences, for example, can be performed by aligning the two sequences for optimal comparison purposes (e.g., gaps can be introduced in one or both of a first and a second amino acid sequences for optimal alignment and non-identical sequences can be disregarded for comparison purposes). In certain embodiments, the length of a sequence aligned for comparison purposes is at least 30%, at least 40%, at least 50%, at least 60%, at least 70%, at least 80%, at least 90%, at least 95%, or substantially 100% of the length of the reference sequence. The amino acids at corresponding amino acid positions are then compared. When a position in the first sequence is occupied by the same amino acid as the corresponding position in the second sequence, then the molecules are identical at that position. The percent identity between the two sequences is a function of the number of identical positions shared by the sequences, taking into account the number of gaps, and the length of each gap, which needs to be introduced for optimal alignment of the two sequences. The comparison of sequences and determination of percent identity between two sequences can be accomplished using a mathematical algorithm. For example, the percent identity between two amino acid sequences can be determined using the algorithm of Meyers and Miller (CABIOS, 1989, 4:11-17), which has been incorporated into the ALIGN program (version 2.0) using a PAM120 weight residue table, a gap length penalty of 12 and a gap penalty of 4. The percent identity between two amino acid sequences can, alternatively, be determined using the GAP program in the GCG software package using an NWSgapdna.CMP matrix.

Polypeptide: As used herein, a “polypeptide”, generally speaking, is a polymer of at least two amino acids attached to one another by a peptide bond. In some embodiments, a polypeptide may include at least 3-5 amino acids, each of which is attached to others by way of at least one peptide bond. Those of ordinary skill in the art will appreciate that polypeptides sometimes include “non-natural” amino acids or other entities that nonetheless are capable of integrating into a polypeptide chain, optionally.

Protein: As used herein, the term “protein” refers to a polypeptide (i.e., a string of at least two amino acids linked to one another by peptide bonds). Proteins may include moieties other than amino acids (e.g., may be glycoproteins, proteoglycans, etc.) and/or may be otherwise processed or modified. Those of ordinary skill in the art will appreciate that a “protein” can be a complete polypeptide chain as produced by a cell (with or without a signal sequence), or can be a portion thereof. Those of ordinary skill will appreciate that a protein can sometimes include more than one polypeptide chain, for example linked by one or more disulfide bonds or associated by other means. Polypeptides may contain L-amino acids, D-amino acids, or both and may contain any of a variety of amino acid modifications or analogs known in the art. Useful modifications include, e.g., terminal acetylation, amidation, methylation, etc. In some embodiments, proteins may comprise natural amino acids, non-natural amino acids, synthetic amino acids, and combinations thereof. The term “peptide” is generally used to refer to a polypeptide having a length of less than about 100 amino acids, less than about 50 amino acids, less than 20 amino acids, or less than 10 amino acids.

### DETAILED DESCRIPTION

The present disclosure encompasses the discovery that protein structure can be predicted and/or generated from amino acid sequence of a protein. Accordingly, the disclosure provides methods, systems, and apparatus for predicting and/or generating protein structures from a sequence, e.g., an amino acid sequence. In some embodiments, a generated or predicted protein structure is used, e.g., for identifying protein interaction partners, for designing modified proteins, and/or for designing a polypeptide sequence.

Methods described herein exploit evolutionary conservation of amino acid interactions to determine protein structure. Evolution conserves interactions between residues that are important to maintaining structure and function by constraining the sets of mutations that are accepted at interacting sites. To determine these constraint couplings for a protein of interest, methods described herein involve generation of a multiple sequence alignment (Remmert et al., (2012) Nat. Methods 9, 173-175) with sufficiently diverse sequences to detect evolutionary covariation and minimize statistical noise. To maximize the power of detection, in some embodiments, methods described herein optimize the trade-off between the number of sequences aligned (i.e., depth) and alignment specificity, a proxy for functional similarity to the query sequence, which is quantified by the sequence range (i.e., breadth) covered by the alignment. In some embodiments, for a protein of length L, at least about 3L sequences and coverage of at least about 0.7×L of the residues in the sequence of interest are used.

To discover residue interactions that are conserved by evolution, methods described herein extract patterns of amino acid coevolution from these sequence alignments (Lapedes et al. (1997) Correlated Mutations in Protein Sequences: Phylogenetic and Structural Effects (Santa Fe, N. Mex.: Santa Fe Institute); Marks et al. (2011) PLoS ONE 6, e28766; Morcos et al. (2011) Proc. Natl. Acad. Sci. USA 108, E1293-E1301). The methods, which use entropy maximization, transform a set of observed amino acid correlations in most or all pairs of sequence positions to a set of position couplings (residue couplings) that best explains the observed data. This set of globally consistent residue couplings may be causative, i.e., reflect residue interactions constrained in evolution. The statistical approach addresses the classic problem of deriving “causation from correlation.” The “global” statistical approach utilized in the methods described herein is different from “local” approaches such as mutual information (MI) and variants thereof (Fodor et al. (2004) Proteins 56, 211-221; Livesay et al. (2012) Methods Mol. Biol. 796, 385-398). The MI of pairs of columns in a sequence alignment is local in that it quantifies covariation for each pair independently of all other pairs, potentially leading to inconsistencies. The simplest inconsistencies in local models are transitive correlations, e.g., correlations between a noncontact pair A-C in a triplet A-B-C that arise from transitive influence in contact pairs A-B and B-C. Thus, pairs with high MI scores are not necessarily constrained by a direct interaction effect, even if they are correlated.

In contrast, methods described herein use entropy maximization to build a probability model for an entire sequence, such that scores for each pair of residues are consistent with other pairs, reducing or preventing high scoring from transitive relationships in the data. Starting with a simple covariance matrix between all pairs of columns in an alignment, entropy maximization gives rise to a formalism that is similar to the well-known inverse Ising model of ferromagnetism (in which there are two states) except that, for protein sequences, each site (i.e., sequence position) can be assigned to 1 of 21 discrete states (20 amino acids or a gap), as in the Potts model in physics. In some embodiments, the numerical parameters in entropy maximization methods described herein (analogous to the spin-spin interactions in the Ising model Hamiltonian) can be computed efficiently by inverting a covariance matrix. Although constrained interactions can arise from diverse evolutionary requirements, many reflect interactions between residues close in space and are thus highly productive as distance constraints for protein folding (Marks et al. (2011) PLoS ONE 6, e28766). In some embodiments, a protein of interest is a membrane protein (e.g., a transmembrane protein). In some such embodiments, predicted coevolved pairs for which structural proximity is unlikely due to presence within a membrane can be removed.

Resulting sets of evolutionary constraints and predicted secondary structure can be interpreted as distance constraints on extended polypeptide chains. Distance geometry and out-of-the-box simulated annealing, e.g., using CNS software (Brunger et al. (1998) Acta Crystallogr. D Biol. Crystallogr. 54, 905-921), can be used to fold a chain ab initio to produce about 500 3D all-atom coordinate models for a protein of interest. In some embodiments, to assess a set of predicted structures for a protein of interest, an automated membrane-specific ranking of the computed models can be used that combines the quality of secondary structure formation, lipid accessibility of residues, and a measure of violation of evolutionary constraints and cluster the structures, excluding predictions not represented in larger clusters.

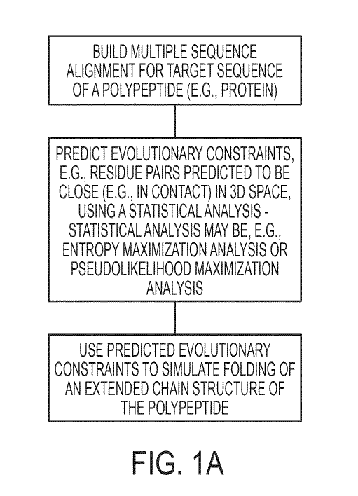

Exemplary methods are depicted schematically in FIGS. 1A and 1B. For example, in FIG. 1A, the method identifies an extended chain structure of a polypeptide (e.g., a protein) from sequence information. First, a multiple sequence alignment is built for a target sequence of a polypeptide. Evolutionary constraints are predicted using a statistical analysis. Evolutionary constraints can be an identification of residue pairs predicted to be close (e.g., in contact) in three-dimensional space. The statistical analysis can be, for example, an entropy maximization analysis or a pseudolikelihood maximization analysis. Once the evolutionary constraints are determined, they are used to simulate folding of an extended chain structure of the polypeptide.

In the exemplary method shown in FIG. 1B, a structure of a protein of interest is predicted and/or generated by first providing an amino acid sequence of the protein of interest. The amino acid sequence can be a known amino acid sequence (e.g., a published amino acid sequence) or the amino acid sequence can be determined for the protein of interest using known methods.

A protein of interest can be any protein or polypeptide, including naturally occurring, recombinant, or synthetically derived proteins or amino acid sequences. A protein of interest can also be a protein naturally expressed in any species. In some embodiments, a protein of interest is, includes, and/or exhibits one or more characteristics of, a soluble protein (e.g., a cytosolic protein or an extracellular protein, e.g., a serum protein). In some embodiments, a protein of interest is, includes, and/or exhibits one or more characteristics of, a membrane protein (e.g., a protein having at least 1, 2, 3, 4, 5, 6, 7, 8, 9, 10, 11, 12, 13, 14, 15, or more transmembrane domains). In some embodiments, all or a portion of a protein of interest is not amenable to structural analysis using one or more standard method (e.g., X-ray crystallography, NMR, mass spectrometry, etc.).

An amino acid sequence of the protein of interest can be used to identify related protein family members. Related protein family members can be identified by, e.g., searching protein databases, such as GenBank, SwissProt, or UniProt, as known to those of skill in the art. In some embodiments, a protein of interest is from a particular species, and related protein family members are or include homologs of a protein of interest from the same species as the protein of interest. In some embodiments, related protein family members are or include homologs of a protein of interest from species that differ from the protein of interest. In some embodiments, related protein family members are or include homologs of a protein of interest from the same and from different species as the protein of interest.

In some embodiments, amino acid sequences of related protein family members share at least about 5%, 10%, 15%, 20%, 25%, 30%, 35%, 40%, 45%, 50%, 55%, 60%, 65%, 70%, 75%, 80%, 85%, 90%, 95%, or 100% homology to the amino acid sequence of the protein of interest. In some embodiments, amino acid sequences of related protein family members share at least about 5%, 10%, 15%, 20%, 25%, 30%, 35%, 40%, 45%, 50%, 55%, 60%, 65%, 70%, 75%, 80%, 85%, 90%, 95%, or 100% identity to the amino acid sequence of the protein of interest. In some embodiments, related protein family members are about 50% to about 200% the length of a protein of interest. In some embodiments, related protein family members are about the same length as the protein of interest.

As depicted in FIG. 1B, the method includes a step of generating a multiple sequence alignment for the protein of interest using all or a portion of the related protein family members identified. In some embodiments, about 50 to about 500000 related protein family members are included in a multiple sequence alignment. In some embodiments, at least about 50, 100, 200, 300, 400, 500, 600, 700, 800, 900, 1000, 1500, 2000, 2500, 3000, 3500, 4000, 4500, 5000, 6000, 7000, 8000, 9000, 10000, 15000, 20000, 25000, 30000, 35000, 40000, 45000, 50000, 60000, 70000, 80000, 90000, 100000, 150000, 200000, or more, related protein family members are included in a multiple sequence alignment.

The next step in the method depicted in FIG. 1B involves calculating a covariance matrix from the multiple sequence alignment. In some embodiments, a covariance matrix is generated by determining (e.g., counting) how often a particular pair of amino acids occurs in a particular pair of positions in any one sequence and summing over all sequences in the multiple sequence alignment. In some embodiments, a covariance matrix has a dimension of about (5L)², (10L)², (15L)², (20L)², (25L)², (30L)², (35L)², (40L)², (45L)², or (50L)², where L is the length (number of amino acids) of the protein of interest. In some embodiments, a covariance matrix has a dimension of about (20L)².

As shown in FIG. 1B, the method includes a step of computing or deriving a measure of causative correlations (i.e., predicted contacts), e.g., using maximum entropy as described in detail below. In some embodiments, causative correlations are computed by taking the inverse of (inverting) the covariance matrix. The causative correlations between a pair of positions are used as predictors of residue-residue contacts. Approximate three-dimensional coordinates for the protein of interest can be generated using, e.g., a distance geometry method, and the coordinates can be refined by molecular dynamics (e.g., simulated annealing), as described below. Further, generated models can be ranked to select a predicted model, e.g., as described below.

In some embodiments, the method of predicting structure of a polypeptide includes generating a multiple sequence alignment for an amino acid sequence of the polypeptide, identifying evolutionary constraints for the polypeptide using a statistical analysis, and simulating folding of an extended chain structure of the polypeptide using the identified constraints, thereby predicting the polypeptide structure. In some embodiments, the statistical analysis used to identify evolutionary constraints from the multiple sequence alignment is an entropy maximization analysis. In other embodiments, the statistical analysis is a pseudolikelihood maximization. The latter is found to be beneficial for certain applications.

### Identification of Coevolving Residue Pairs Using Maximum Entropy

In some embodiments, a multiple sequence alignment can be represented as an M×L matrix {Aᵢ^{m}} in which each row corresponds to one of m=1, . . . , M proteins and each column to one of i=1, . . . , L sequence positions. Each matrix element Aᵢ^{m} can be either one of the 20 standard amino acids or the gap character, and thus have q=21 different values.

Then, the frequency of an amino acid A in column i of the alignment is given by

$${f}_{i} ( A ) ≡ \frac{1}{M} {\sum }_{m = 1}^{M} δ ( {A}_{i}^{m} , A ) \qquad ( 1 )$$

with counts obtained using the Kronecker-delta δ(a, b), which equals 1 if a=b, 0 else. The frequency of a pair of amino acids A and B in columns i and j, respectively, can be defined as

$${f}_{ij} ( A , B ) ≡ \frac{1}{M} {\sum }_{m = 1}^{M} δ ( {A}_{i}^{m} , A ) δ ( {A}_{j}^{m} , B ) \qquad ( 2 )$$

in an analogous way. If the empirical frequency distribution of amino acids A and B between two columns i and j is independent, the product of the individual frequency distributions fᵢ(A)(B) is roughly equal to the joint frequency distribution fᵢ(A,B), while a deviation indicates a correlation between the two columns.

Frequency counts as defined in Equations (1) and (2) can exhibit uneven sampling of sequence space, e.g., due to experimental bias. To decrease the influence of sampling bias on the estimation of correlations, sequences in the multiple alignment can be down-weighted based on the number of neighbors with sequence identity above a similarity threshold θ (0<θ≦1).

Formally, for each sequence m the number of sequences in the alignment (including m) which have at least θL aligned identical residues can be calculated as

$${k}_{m} ≡ {\sum }_{n = 1}^{M} H ( {\sum }_{i = 1}^{L} δ ( {A}_{i}^{m} , {A}_{i}^{n} ) - θ L ) \qquad ( 3 )$$

with H denoting the unit step function. Assigning a weight of 1/kₘ to each sequence m, the frequency counts from Equations (1) and (2) can be redefined as

$$\begin{matrix}{f}_{i} ( A ) ≡ \frac{1}{λ + {M}_{eff}} ( \frac{λ}{q} + {\sum }_{m = 1}^{M} \frac{1}{{k}_{m}} δ ( {A}_{i}^{m} , A ) ) \\ and & ( 4 ) \\ {f}_{ij} ( A , B ) ≡ \frac{1}{λ + {M}_{eff}} ( \frac{λ}{{q}^{2}} + {\sum }_{m = 1}^{M} \frac{1}{{k}_{m}} δ ( {A}_{i}^{m} , A ) δ ( {A}_{j}^{m} , B ) ) & ( 5 )\end{matrix}$$

respectively. In both cases, M_{eff}=Σₘ₌₁^{M} 1/kₘ is the effective number of sequences in the alignment after weighting, and is a pseudocount term to avoid non-zero entries in the correlation matrix. Initial tests suggest a choice of θ=0.7 and λ=0.5 for reasonable performance (Marks et al. (2011) PLoS ONE 6, e28766; Morcos et al. (2011) Proc. Natl. Acad. Sci. USA 108, E1293-E1301).

A measure used for calculating the correlation between two columns in a sequence alignment is mutual information (MI), which is defined as

$${MI}_{ij} = {\sum }_{{A}_{i} , {A}_{j} = 1}^{q} {f}_{ij} ( {A}_{i} , {A}_{j} ) ln ( \frac{{f}_{ij} ( {A}_{i} , {A}_{j} )}{{f}_{i} ( {A}_{i} ) {f}_{j} ( {A}_{j} )} ) \qquad ( 6 )$$

for alignment columns i and j. MIᵢⱼ is the difference entropy between the observed pair frequencies fᵢⱼ(Aᵢ,Aᵢ) and the expected frequency fᵢ(Aᵢ)fⱼ(Aⱼ) if both columns were statistically independent. MI is an inherently local measure which assumes statistical independence between different pairs of alignments columns, using globally inconsistent terms fᵢⱼ(Aᵢ,Aⱼ). Since MI is dominated by transitive pair correlations, it fails to capture residue pair proximity and cannot be used to predict the 3D structure of proteins (Marks et al. (2011) PLoS ONE 6, e28766; Morcos et al. (2011) Proc. Natl. Acad. Sci. USA 108, E1293-E1301).

To overcome this limitation, in some embodiments, methods described herein (e.g., “MaxEnt”) are based on a global probability model P(A₁, . . . , A_{L}) of the protein family alignment that describes the joint probability of a sequence A₁, . . . , A_{L} to be a member of the family. Since the estimation of such a probability distribution is an infeasible task in the general case, the problem is simplified to learning a distribution that is consistent with the multiple alignment up to pair frequency terms. More precisely, the marginal distributions for the single column and column pair probabilities have to agree with the empirical frequencies, i.e.,

$$\begin{matrix}{P}_{i} ( {A}_{i} ) ≡ {\sum }_{{\{ {A}_{k} = 1 , … , q \}}_{k \neq i}} P ( {A}_{1} , … , {A}_{L} ) = {f}_{i} ( {A}_{i} ) \\ and & ( 7 ) \\ {P}_{ij} ( {A}_{i} , {A}_{j} ) ≡ {\sum }_{{\{ {A}_{k} = 1 , … , q \}}_{k \neq i , j}} P ( {A}_{1} , … , {A}_{L} ) = {f}_{ij} ( {A}_{i} , {A}_{j} ) . & ( 8 )\end{matrix}$$

As there are many distributions which can satisfy (7) and (8), a second condition can be imposed by requiring a maximally flat distribution. This is equivalent to maximizing the entropy

$$S = - {\sum }_{\{ {A}_{i} \vert i = 1 , … , L \}} P ( {A}_{1} , … , {A}_{L} ) ln P ( {A}_{1} , … , {A}_{L} ) \qquad ( 9 )$$

of the probability distribution P. After introducing Lagrange multipliers to enforce the inconsistency requirements, it can be shown that the solution of the optimization problem is of the form

$$P ( {A}_{1} , … , {A}_{L} ) = \frac{1}{z} exp \{ {\sum }_{1 \leq i \leq j \leq L} {e}_{ij} ( {A}_{i} , {A}_{j} ) + {\sum }_{1 \leq i \leq L} {h}_{i} ( {A}_{i} ) \} \qquad ( 10 )$$

with normalization constant

$$Z = {\sum }_{\{ {A}_{i} \vert i = 1 , … , L \}} exp \{ {\sum }_{1 \leq i \leq j \leq L} {e}_{ij} ( {A}_{i} , {A}_{j} ) + {\sum }_{1 \leq i \leq L} {h}_{i} ( {A}_{i} ) \} . \qquad ( 11 )$$

Parameters eᵢⱼ satisfying the given conditions can be determined efficiently in a mean field or a Gaussian approximation (for detailed derivations of the approximation see Lezon et al. (2006) Proc. Natl. Acad. Sci. USA 103, 19033-19038; Lapedes et al., (1999) Proceedings of the IMS/AMS International Conference on Statistics in Molecular Biology and Genetics 33, 236-256; Marks et al. (2011) PLoS ONE 6, e28766; Morcos et al. (2011) Proc. Natl. Acad. Sci. USA 108, E1293-E1301). The effective residue couplings eᵢⱼ are the result of the matrix inversion

eᵢⱼ(Aᵢ,Aⱼ)=−(C⁻¹)ᵢⱼ(Aᵢ,Aⱼ) (12)

where C is the correlation matrix with entries

Cᵢⱼ(Aᵢ,Aⱼ)=fᵢⱼ(Aᵢ,Aⱼ)−fᵢ(Aᵢ)fᵢ(Aⱼ) (13)

describing the deviation from independence for each pair of amino acids between two alignment columns i and j.

As a replacement for the globally inconsistent terms fᵢⱼ in MI, globally consistent effective pair probabilities for a certain amino acid pair in two alignment columns can be calculated as

$${P}_{ij}^{DIR} ( {A}_{i} , {A}_{j} ) = \frac{1}{z} exp \{ {e}_{ij} ( {A}_{i} , {A}_{j} ) + {\tilde{h}}_{i} ( {A}_{i} ) + {\tilde{h}}_{j} ( {A}_{j} ) \} \qquad ( 14 )$$

The single-column probabilities (fields) \tilde{h}ᵢ(Aᵢ) and \tilde{h}ⱼ(Aⱼ) can be obtained by enforcing the single column frequency count condition from Equation (7) in

$${{\sum }_{{A}_{j} = 1}}^{q} {P}_{ij}^{Dir} ( {A}_{i} , {A}_{j} ) ≅ {f}_{i} ( {A}_{i} ) \qquad ( 15 )$$

and analogously for fⱼ(Aⱼ) by summing over all Aᵢ. The term Z is calculated by normalization.

Then, by replacing the globally inconsistent terms fᵢⱼ(Aᵢ,Aⱼ) in MI with globally consistent effective pair probabilities Pᵢⱼ^{Dir}(Ai,Aj), the evolutionary constraint between a pair of residues i and j (formerly called direct information, DI) can be quantified by

$${EC}_{ij} = {DI}_{ij} = {{\sum }_{{A}_{i} , {A}_{j} = 1}}^{q} {P}_{ij}^{Dir} ( {A}_{i} , {A}_{j} ) ln ( \frac{{P}_{ij}^{Dir} ( {A}_{i} , {A}_{j} )}{{f}_{i} ( {A}_{i} ) {f}_{j} ( {A}_{j} )} ) \qquad ( 16 )$$

ECᵢⱼ measures the difference entropy between the learned distribution Pᵢⱼ^{Dir}(Ai,Aj) and the expected distribution fᵢ(Aᵢ)fⱼ(Aⱼ) under statistical independence, with higher EC values corresponding to a stronger direct coevolution signal between two residues. The set of all possible residue pairs in a protein sequence can therefore be ranked by EC value in decreasing order and used as input for deriving restraints for 3D structure prediction.

### Identification of Evolutionary Constraints Using Pseudolikelihood Maximization

A pseudolikelihood maximization (PLM) statistical analysis is described in Ekeberg et al., Physical Review E, vol. 87, 012707 (2013), “Improved contact prediction in proteins: Using pseudolikelihoods to infer Potts models,” portions of which are excerpted in this section. For example, let σ=(σᵢ, σ₂, . . . , σ_{N}) represent the amino acid sequence of a domain with length N. Each σᵢ takes on values in {1, 2, . . . , q}, with q=21: one state for each of the 20 naturally occurring amino acids and one additional state to represent gaps. A multiple sequence alignment (MSA) with B aligned sequences from a domain family is written as an integer array {σ^{(b)}}_{b=1}^{B}, with one row per sequence and one column per chain position. Given an MSA, the empirical individual and pairwise frequencies can be calculated as

$${f}_{i} ( k ) = \frac{1}{B} {\sum }_{b = 1}^{B} δ ( {σ}_{i}^{( b )} , k ) , \\ {f}_{ij} ( k , l ) = \frac{1}{B} {\sum }_{b = 1}^{B} δ ( {σ}_{i}^{( b )} , k ) δ ( {σ}_{j}^{( b )} , l ) , \qquad ( 17 )$$

where δ(a,b) is the Kronecker symbol, taking value 1 if both arguments are equal and 0 otherwise. The quantity fᵢ(k) is the fraction of sequences for which the entry on position i is amino acid k, gaps counted as a 21^{st} amino acid. The quantity fᵢⱼ(k,l) is the fraction of sequences in which the position pair (i,j) holds the amino acid combination (k,l). Connected correlations are given as

cᵢⱼ(k,l)=fᵢⱼ(k,l)−fᵢ(k)fⱼ(l). (18)

A generalized Potts model is a probabilistic model P(σ) which can reproduce the empirically observed fᵢ(k) and fᵢⱼ(k,l). It is defined as

$$P ( σ ) = \frac{1}{Z} exp ( {\sum }_{i = 1}^{N} {h}_{i} ( {σ}_{i} ) + {\sum }_{1 \leq i < j \leq N} {J}_{ij} ( {σ}_{i} , {σ}_{j} ) ) , \qquad ( 19 )$$

in which hᵢ(σi) and Jᵢⱼ(σᵢ, σⱼ) are parameters to be determined via the constraints

$$P ( {σ}_{i} = k ) = {\sum }_{{σ}_{{a}_{i} = k}} P ( σ ) = {f}_{i} ( k ) , \\ P ( {σ}_{i} = k , {σ}_{j} = 1 ) = {{\sum }_{{σ}_{{a}_{j} = l}}}_{{a}_{i} = k} P ( σ ) = {f}_{ij} ( k , l ) . \qquad ( 20 )$$

Given a set of independent equilibrium configurations {σ^{(b)}}_{b=1}^{B} of the model, Eq. (19), one statistical approach of inferring parameters {h, J} is to let those parameters maximize the likelihood, i.e., the probability of generating the data set for a given set of parameters. This is equivalent to minimizing the rescaled negative log-likelihood function

$$l = - \frac{1}{B} {\sum }_{b = 1}^{B} log P ( {σ}^{( b )} ) . \qquad ( 21 )$$

Pseudolikelihood substitutes the probability in (21) by the conditional probability of observing one variable σr given observations of all the other variables σ_{\r}. That is, the following holds

$$P ( {σ}_{r} = {σ}_{r}^{( b )} \vert {σ}_{\backslash r} = {σ}_{\backslash r}^{( b )} ) = \frac{exp ( {h}_{r} ( {σ}_{r}^{( b )} ) + {\sum }_{{i = 1}_{i \neq r}}^{N} {J}_{ri} ( {σ}_{r}^{( b )} , {σ}_{i}^{( b )} ) )}{{\sum }_{i = 1}^{q} exp ( {h}_{r} ( l ) + {\sum }_{{i = 1}_{i \neq r}}^{N} {J}_{ri} ( l , {σ}_{i}^{( b )} ) )} , \qquad ( 22 )$$

where Jᵣᵢ(l,k) means Jᵢᵣ(k,l) when i<r. Given a multiple sequence alignment (MSA), the conditional likelihood can be maximized by minimizing

$${g}_{r} ( {h}_{r} , {J}_{r} ) = - \frac{1}{B} {\sum }_{b = 1}^{B} log [ {P}_{( {h}_{r} , {J}_{r} )} ( {σ}_{r} = {σ}_{r}^{( b )} \vert {σ}_{\backslash r} = {σ}_{\backslash r}^{( b )} ) ] . \qquad ( 23 )$$

Note that this only depends on hᵣ and Jᵣ={Jᵢᵣ}_{i≠r}, that is, this only depends on the parameters featuring node r. If (23) is used for all r, this leads to unique values for the parameters hᵣ but typically different predictions for J_{rq} and J_{qr}, which should be the same. Therefore, minimization of (23) is supplemented by a procedure to reconcile different values of J_{rq} and J_{qr}, For example, one may simply use their average,

$$\frac{1}{2} ( {J}_{rq} + {J}_{qr}^{T} ) .$$

One could reconcile different J_{rq} and J_{qr} by minimizing an objective function adding gᵣ for all nodes:

$$\begin{matrix}{I}_{pseudo} ( h , J ) = {\sum }_{r = 1}^{N} {g}_{r} ( {h}_{r} , {J}_{r} ) \\ = - \frac{1}{B} {\sum }_{r = 1}^{N} {\sum }_{b = 1}^{B} log [ {P}_{( {h}_{r} , {J}_{r} )} ( {σ}_{r} = {a}_{r}^{( b )} \vert {σ}_{\backslash r} = {σ}_{\backslash r}^{( b )} ) ] .\end{matrix} \qquad ( 24 )$$

Minimizers of l_{pseudo} generally do not minimize l; the replacement of likelihood with pseudolikelihood alters the outcome. Replacing l with l_{pseudo} resolves the computational intractability of the parameter optimization problem; instead of depending on the full partition function, the normalization of the conditional probability, (22), contains only a single summation over the q=21 Potts states. The intractable average over the N−1 conditioning spin variables is replaced by an empirical average over the data set in Eq. (24).

Regularization is performed to avoid overfitting. In the pseudolikelihood maximization (PLM) approach, a penalty term is added to the objective function:

$$\{ {h}^{PLM} , {J}^{PLM} \} = {arg min}_{( h , J )} \{ {l}_{pseudo} ( h , J ) + R ( h , J ) \} . \qquad ( 25 )$$

In one example, the term R is selected as an l₂ norm,

$${R}_{{l}_{2}} ( h , J ) = {λ}_{h} {\sum }_{r = 1}^{N} {‖ {h}_{r} ‖}_{2}^{2} + {λ}_{J} {\sum }_{1 \leq i < j \leq N} {‖ {J}_{ij} ‖}_{2}^{2} , \qquad ( 26 )$$

with two regularization parameters, λₕ and λ_{J}, the field and coupling parameters.

Sequence reweighting is performed to mitigate effects of uneven sampling. In the PLM approach, the following may be used:

$${l}_{pseudo} ( h , J ) = - \frac{1}{{B}_{eff}} {\sum }_{b = 1}^{B} {w}_{b} {\sum }_{r = 1}^{N} log [ {P}_{\{ {h}_{r} , {I}_{r} \}} ( {σ}_{r} = {σ}_{r}^{( b )} \vert {σ}_{\backslash r} = {σ}_{\backslash r}^{( b )} ) ] . \qquad ( 27 )$$

Each sequence is considered to contribute a weight w_{b}, instead of the standard weight of ‘one’ that is applicable in samples that are independent and identically distributed.

Interaction scores in the PLM approach can use the Frobenius norm (FN):

$${‖ {J}_{ij} ‖}_{2} = \sqrt{{\sum }_{k , l = 1}^{q} {{J}_{ij} ( k , l )}^{2}} . \qquad ( 28 )$$

The interaction parameters are inferred using the pseudolikelihood and the regularization, then are changed to a zero-sum gauge:

Jᵢⱼ′(k,l)=Jᵢⱼ(k,l)−Jᵢⱼ(•,l)−Jᵢⱼ(k,•)+Jᵢⱼ(•,•), (29)

where a center dot denotes the average over the identified position. An example FN score is therefore as follows:

$${S}_{ij}^{FN} = {‖ {J}_{ij}^{′} ‖}^{2} = \sqrt{{\sum }_{k , l = 1}^{q} {{J}_{ij}^{′} ( k , l )}^{2}} . \qquad ( 30 )$$

This can be adjusted by an average-product correction (APC) term, resulting in the following scoring function:

$${S}_{ij}^{CN} = {δ}_{ij}^{FN} - \frac{{S}_{\cdot j}^{FN} {S}_{i \cdot }^{FN}}{{S}_{\cdot \cdot }^{FN}} , \qquad ( 31 )$$

where CN represents corrected norm.

Thus, evolutionary constraints, e.g., residue pairs predicted to be close in 3D space, can be identified from a multiple sequence alignment (MSA) using Pseudolikelihood Maximization (PLM). Variations of the above approach may be made, for example, by implementing different methods for regularization, sequence reweighting, and identification of interaction scores.

### Filtering of Evolutionary Couplings for Membrane Proteins

In some embodiments, a protein of interest is a membrane protein. As discussed herein, described methods return a ranked set of evolutionary constraints, with the highest-ranked pairs explaining best all observed correlations in a multiple sequence alignment. Yet, some of the residue pairs might show strong couplings for reasons other than spatial proximity. To reduce their possible negative influence on 3D structure prediction accuracy, potentially distant pairs can be removed by a simple set of blind filters before folding. Filtering steps can be performed based on the sequence distance of residues and the conservation of the corresponding columns in a multiple sequence alignment. In some embodiments, neighbors in an amino acid sequence covary despite not being in contact in 3D space. For example, this can be true for amino acid pairs with four or five residues in between (Marks et al. (2011) PLoS ONE 6, e28766). For this reason, the EC scores of all pairs i,j can be set to zero if their sequence distance |i−j|≦5, thus ignoring any coupling between them. Fully conserved alignment columns do not lead to any correlation signal by definition, since fᵢⱼ(Aᵢ,Aⱼ)−f(Aᵢ)fⱼ(Aⱼ)=0 for all combinations of Aᵢ and Aⱼ. Similarly, highly conserved columns can lead to an uncertain correlation signal due to the small number of variations (Fodor et al. (2004) Proteins 56, 211-221). To exclude possible false positive pairs arising from highly conserved positions, the frequency of the most prevalent amino acid for each alignment column can be calculated and a residue pair can be removed if the conservation of any partner exceeds about 95%. An exception to the conservation filter can be made for cysteine-cysteine pairs to allow for disulfide bridges. Even if the conservation of a cysteine residue is higher than about 95%, one single pair can be allowed for that residue if its highest-ranked partner is also a cysteine residue.

Resolution with Constraints from Membrane Secondary Structure and Topology

Protein secondary structure and predicted transmembrane topology of α-helical transmembrane proteins can be predicted from multiple sequence alignments (Rost et al. (1993) J. Mol. Biol. 232, 584-599; Jones (1999) J. Mol. Biol. 292, 195-202; Rost et al. (1995) Protein Sci. 4, 521-533; Rost et al. (1996) Protein Sci. 5, 1704-1718; Kall et al. (2005) Bioinformatics 21 (Suppl 1), i251-i257; Bernsel et al. (2009) Nucleic Acids Res. 37 (Web Server issue), W465-W468; Nugent et al. (2009) BMC Bioinformatics 10, 159) and these predictions may or may not be consistent with the evolutionary constraints predicted using methods described herein. In some embodiments, secondary structure and topology predictions can be preferred, and any predicted evolutionary couplings which may conflict with these predictions can be excluded.

Since different topology predictors may perform to varying levels of performance on certain classes of proteins, a manual metaprediction survey can be performed using known methods. For example, topology can be predicted using MEMSAT-SVM (Nugent et al. (2009) BMC Bioinformatics 10, 159) and compared against predictions obtained using methods described herein by MEMSAT (Jones (2007) Bioinformatics 23, 538-544), PolyPhobius (Kall et al. (2005) Bioinformatics 21 (Suppl 1), i251-i257), and/or the TOPCONS metaprediction method (Bernsel et al. (2009) Nucleic Acids Res. 37 (Web Server issue), W465-W468). In some embodiments, MEMSAT-SVM is a preferred method. In cases of major conflicts between methods, L (length of alignment) contact pairs can be visualized as a predicted contact map. The most likely topology assignment can be chosen by searching for patterns in antiparallel and parallel orientation to the diagonal of the predicted contact map, which are characteristic for parallel and antiparallel helix arrangements. As topology prediction only gives the position and direction of transmembrane helix segments, but does not include the secondary structure of residues outside the membrane, secondary structure can be additionally predicted using PSIPRED (Jones (1999) J. Mol. Biol. 292, 195-202). Secondary structure prediction of the entire sequence can be obtained by creating an overlay of PSIPRED secondary structure and predicted topology according to the following scheme: Residues outside a predicted transmembrane segment can be assigned the corresponding PSIPRED prediction, whereas residues within predicted transmembrane segments can be assigned the secondary structure state helix by default.

Using the predicted transmembrane topology and secondary structure, those predicted evolutionary couplings that clash with these predictions can be filtered out. The predicted topology allows straightforward removal of pairs of residues outside the membrane bilayer if both residues are on either side of the membrane and thus cannot be in physical contact (inside-outside filtering). Additionally, in some embodiments, inferred contacts between pairs of residues outside and within the membrane are only accepted if the residue inside the membrane is close enough to the right face of the membrane. For this filter, each transmembrane helix segment can be divided into three equal-sized subsegments. Any contact other than with intra-membrane residues in the subsegment on the right side of the membrane bilayer can then be discarded. Contacts with the first subsegment can be kept to account for contacts involving reentrant helices and loops as well as loops reaching inside channels or cavities. A second topology-based filtering step (z-plane filtering) can refine the idea of the first filter and can utilize the observation that for two residues within transmembrane segments to be in contact, they should be approximately in the same z-plane within the membrane or be filtered otherwise.

In an exemplary analysis, start(h) and end(h) denote the sequence index of the first and last residue in a predicted transmembrane helix segment h. For a residue i in helix h, the z-plane value z(i, h) can be calculated according to

$$z ( i , h ) = \frac{i - start ( h )}{end ( h ) - start ( h )} . \qquad ( 32 )$$

Note that z-plane values are comparable between non-kinked transmembrane helices with different lengths and tilt angles because they are normalized by the length of the transmembrane segment. Since the z-value depends on the orientation of a transmembrane helix (sequence runs outside-inside or inside-outside from N to C terminus), in a pair of parallel transmembrane helices h₁ and h₂ with the same orientation the difference d in z-values for a pair of residues (i,j) is calculated as

dₚₐᵣₐₗₗₑₗ(i,j)=|z(i,h₁)−z(j,h₂)|. (33)

For a pair of antiparallel transmembrane helices with opposite orientations, it is given by

dₐₙₜᵢₚₐᵣₐₗₗₑₗ(i,j)=|z(i,h₁)−(1−z(j,h₂))|. (34)

In both cases, a z-value difference of 0 means that both residues are in the same z-plane within the membrane, while a z-value of 1 is equivalent to residues i and j being in the opposite faces of the lipid bilayer. In some embodiments, evolutionary constraints with d≧0.3 are removed, balancing between the filtering of distant pairs and possible larger values of d due to kinked helices or inaccuracies in the predicted location of transmembrane segments. In some embodiments, helix kinks can be predicted by locating proline residues in a multiple sequence alignment.

In some embodiments, contacts that are implausible due to conflicts with local predicted secondary structure can also be filtered based on the same principles as described in (Marks et al. (2011) PLoS ONE 6, e28766), giving preference to secondary structure. Due to the inclusion of the same filtering protocol for residues outside the membrane, the methods described herein can jointly model both membrane-integral and soluble domains.

### Folding Using Distance Geometry and Simulated Annealing and Evolutionary Couplings

After generating a set of evolutionary constraints (e.g., filtered evolutionary constraints), these residue pairs can be used to derive restraints for folding a protein of interest from an extended polypeptide chain using standard distance geometry and simulated annealing methods from NMR-based structure determination. The first step toward folding is or includes deriving restraints both on the global structure using a set of evolutionary constraints, and on the local peptide backbone using information from predicted secondary structure. These restraints can then be used to compute all-atom 3D structure models from a fully extended polypeptide. For example, to confine the position of an evolutionarily constrained residue pair i and j, a distance restraint of 4 Å with a maximum distance of 7 Å can be placed on the Cα atoms of both residues. The same type of restraint can be put on the Cβ atoms of both residues, unless one residue is a glycine. Since the evolutionary covariation of two residues in an alignment indicates that the side chains are in contact, one heavy side chain atom for each residue type that is the most distant from the Cα atom can also be chosen. The distance between these side chain representatives of both residues can then be limited to 2-4 Å, with a default of 3 Å. As distance geometry uses weights which can be used to down weight to lower-ranked restraints, increasing numbers of evolutionary constraints can be grouped into bins in steps of 10, e.g., 10, 20, 30 and so on. In some embodiments, folding can be started with a bin size of 30, up to L, the length of the modeled protein. Selecting the bins that give the best performance can be a problem which can be addressed after folding by a blind ranking of the generated models across all bins.

However, in the simulated annealing stage, weights can be assigned to restraints. For example, r(i,j) can be the rank of an evolutionary constraint between residues i and j, starting with r(i,j)=1 for the highest-ranked constraint. Then the corresponding distance restraint can be assigned a weight of 10/r(i,j), giving preference to high-ranked evolutionary constraints and downweighting lower ones. Additionally, as the residue pairs have a sequence distance of at least six amino acids and do not constrain the local geometry of the polypeptide backbone, further restraints can be supplied to support the formation of α-helices and β-strands based on predicted secondary structure. Making use of the overlay of topology and predicted secondary structure, distance restraints between specific atom pairs obtained from a survey of globular proteins can be used in the distance geometry and simulated annealing stages as described previously (Marks et al. (2011) PLoS ONE 6, e28766). Additionally, idealized α-helix/β-strand dihedral angle restraints can be imposed on main chain heavy atoms of subsequent residues to further improve models in the simulated annealing stage. In some embodiments, secondary structure restraints can be strongly upweighted relative to EC-based restraints to improve overall 3D prediction accuracy.

Next, all-atom 3D structures of a protein are computed using an appropriate system, such as the Crystallography & NMR System (CNS, version 1.21) (Brunger (2007) Nat. Protoc. 2, 2728-2733). A default protocol can be employed for NMR structure determination from sparse constraints consisting of input scripts for distance geometry, simulated annealing and energy minimization stages as described previously (Marks et al. (2011) PLoS ONE 6, e28766). All script inputs are available on the website evold.org/transmembrane. For each bin, i.e., particular number of used evolutionary constraints, initial trial structures (e.g., about 5-50, e.g., about 20 initial trial structures) can be generated from an extended polypeptide using, e.g., the Havel-Crippen algorithm (Havel et al. (1983) J. Theor. Biol. 104, 359-381) for distance geometry. Inputs used in this stage can include the distance restraints derived from the evolutionary constraints, and/or local distance restraints based on predicted secondary structure and topology. Each of the generated trial structures can subsequently be subjected to a simulated annealing protocol with an energy function consisting of the same distance restraints as used in the distance geometry stage, and optionally additional dihedral angle constraints derived from predicted secondary structure. In this stage, distance restraints from evolutionary constraints can be assigned weights according to their rank. After annealing, each model can be further refined in two or more stages of energy minimization with the CNS force field. The first stage can consist of multiple cycles (e.g., about 5, 10, 15, 20, or more) of multiple steps (e.g., about 10, 50, 100, 150, 200, 250, 300, 400, 500, or more) of Powell minimization including the same restraints as in the simulated annealing stage, while the second stage adds hydrogen bonds and further minimizes energy without added restraints.

In some embodiments, folding about 20 models for each bin can leave a few hundred fully finished models per protein. For example, starting with 30 evolutionary constraints for a protein of length 300 and adding 10 restraints per bin up to 300 restraints, 28×20=560 models can be generated. CNS structure calculation can be straightforwardly parallelized using one CPU per bin, allowing the full set of models to be folded in under an hour even for very long sequences.

### Ranking of Predicted Models

The number of evolutionary constraints used to fold a particular protein can vary. Too few may not be sufficient to accurately determine the fold of the protein, while the declining accuracy of additional evolutionary constraints may lead to worse models due to disruptive false positive contacts. Additionally, the sparsity of used constraints can lead to the formation of global or local mirrors (Pastore et al. (1991) Proteins 10, 22-32). In some embodiments, structures can be manually assessed for plausibility by clustering structures. In some embodiments, a known model quality assessment program (MQAPs) can be used to rank globular protein models, e.g., a method adapted for α-helical transmembrane proteins (Ray et al. (2010) Bioinformatics 26, 3067-3074). In some embodiments, a MQAP is used based on the agreement between various features predicted from sequence and the readout of the feature in each of the folded models. In some embodiments, one or more of the following three features can be used to rank the models.

(1) Agreement between predicted helical secondary structure and resulting secondary structure. Predicted secondary structure that violate secondary structure integrity can be downranked. In some embodiments, known methods are used for secondary structure overlay for scoring and determining actual secondary structure, such as using assignSS (Srinivasan et al. (1999) Proc. Natl. Acad. Sci. USA 96, 14258-14263) or DSSP (Kabsch et al. (1983) Biopolymers 22, 2577-2637.). For each model m, the secondary structure agreement score ssa(m) is given by

$$ssa ( m ) = \frac{nH}{{N}_{H}} \qquad ( 35 )$$

where n_{H} is the number of residues that are both predicted to be in a helix and assigned to be in a helix by assignSS, while N_{H} is the total number of residues predicted to be in a helix.

(2) Lipid exposure agreement. The agreement of the predicted lipid exposure of residues with the actual exposure in a model can be evaluated. Within the lipid bilayer, residues can either be buried in the core of the protein or face the membrane lipids surrounding the protein. Violation of this predicted property may therefore give an indication whether residues are facing an incorrect environment, e.g., due to mirror image formation or a non-optimal number of restraints.

In some embodiments, lipid exposure can be predicted using, e.g., MPRAP (Illergard et al. (2010) BMC Bioinformatics 11, 333), which outputs an estimated relative lipid exposure for each residue in an input sequence. In some embodiments, scoring can be limited to residues that are predicted to be within transmembrane helices. Actual relative lipid exposure in a model can be assigned with, e.g., NACCESS (Hubbard et al. (1993) NACCESS computer program. Department of Biochemistry and Molecular Biology, University College London) which is an implementation of the original rolling sphere algorithm by Lee et al. (J. Mol. Biol. 55, 379-400 (1971)). In some embodiments, a sphere size of about 2.2 Å can be used to approximate the size of a CH₂ group of a lipid molecule, and the differences between predicted and actual relative lipid accessibility can be summed. For example, the lipid exposure agreement score of a model m can be defined as

$$lipid ( m ) = {\sum }_{r ∈ {R}_{H}} \vert {RLE}_{pred} ( r , m ) - {RLF}_{assigned} ( r , m ) \vert \qquad ( 36 )$$

for the set R_{H} of residues in transmembrane helices and RLE denoting relative lipid exposure in Å².

(3) Evolutionary constraint satisfaction. In some embodiments, a method described by Miller et al. (Bioinformatics 24, 1575-1582 (2008)) can be adapted as follows: if n evolutionary constraints are used to fold and L is the length of the modeled sequence, the remaining evolutionary constraints of rank n+1 to 3L can be used to assess the model with the additional information contained in these pairs. The evolutionary constraint satisfaction (ecs) score can then be defined by

$$ecs ( m ) = {\sum }_{i = n + 1}^{3 L} max ( 0 , d ( {P}_{i} , {P}_{j} ) - 7 ) \qquad ( 37 )$$

where d(Pi, Pj) measures the 3D distance between residues i and j predicted to be in contact by an evolutionary constraint. In some embodiments, only distances >about 7 Å are summed (any distance below is considered satisfied).

Final ranking can combine some or all of the three scores by simple summation without optimizing the individual contribution of each score. Since both the lipid exposure agreement and constraint satisfaction scores cannot be straightforwardly normalized to a limited range, a transformation can be applied to all scores which is conceptually related to z-scores. For each of the scores s in {ssa, lipid, ecs}, based on the full set of models M the mean

$${μ}_{s} ( M ) = \frac{1}{\vert M \vert} {\sum }_{m ∈ M} s ( m ) \qquad ( 38 )$$

can be calculated, and the sample standard deviation

$${σ}_{s} ( M ) = \sqrt{\frac{1}{\vert M \vert - 1} {\sum }_{m ∈ M} {( s ( m ) - {μ}_{s} ( M ) )}^{2}} \qquad ( 39 )$$

of the distribution of the score s across all models in M can be calculated. With regard to the distribution on M, the z-score of a particular model m can then be given as the signed number of standard deviations the score s(m) is away from the mean of the distribution:

$${z}_{s} ( m , M ) = \frac{s ( m ) - {μ}_{s} ( M )}{{σ}_{s} ( M )} \qquad ( 40 )$$

The final composite score z(m, M) of a model m with regard to a full set of models M can be defined as

z(m,M)=zₛₛₐ(m,M)+(−Z_{lipid}(m,M))+(−zₑₘ(m,M)) (41)

and can be used to rank models, with the highest z(m, M) corresponding to the model that shows the best agreement of features. The signs of z_{lipid} and zₑₘ are inverted in the sum, because in both cases lower values of the score indicate better agreement.

Finally, the models can be clustered by comparing all pairwise structural comparison.

Besides calculating a blind ranking based on feature agreement, all generated models for a protein can also be subjected to Cα-RMSD-based single-linkage clustering using, e.g., MaxCluster (Siew et al. (2000) Bioinformatics 16, 776-785) with default parameters. In some embodiments, high-ranked singletons can be eliminated from the predictions of membrane proteins of unknown structures, for all ranking scores, clustering results (see, e.g., evold.org/transmembrane).

### Quality Assessment

To measure the accuracy of 3D structure predictions, all generated models for a target protein can be compared to an experimental structure by calculating the Cα-RMSD and template modeling (TM) scores (Zhang et al. (2004) Proteins 57, 702-710) using, e.g., the MaxCluster program (Siew et al. (2000) Bioinformatics 16, 776-785). Before comparison, the experimental structure can be restricted to the modeled region. Since Maxcluster performs sequence-dependent structural alignments, the PDB sequence and a modeled sequence can be aligned and any differing residues can also be excluded from comparison. Based on the optimal superposition, the Cα-RMSD between an experimental structure E and a predicted model P describes the RMS positional deviation of aligned Cα atoms (taken as residue centers). It can be calculated as

$${C}_{α} - RMSD ( E , P ) = \sqrt{{\sum }_{i} \frac{{d ( {E}_{i} , {P}_{i} )}^{2}}{N}} \qquad ( 42 )$$

where d(Eᵢ, Pᵢ) is the 3D distance between the Cα atoms of the ith corresponding residue pair in the experimental and predicted structure, and N is the total number of aligned pairs. While the Cα-RMSD is an established measure in assessing the quality of structure prediction methods, it is sensitive to outliers and can give rather high values for larger proteins. To overcome these limitations, (Zhang et al. (2004) Proteins 57, 702-710) developed the TM score, which for an experimental structure E and a predicted model P is given by

$$TM - score ( E , P ) = max [ \frac{1}{{L}_{T}} {\sum }_{i ∈ {R}_{A}} \frac{1}{1 + {( \frac{d ( {E}_{i} , {P}_{i} )}{{d}_{0} ( {L}_{T} )} )}^{2}} ] \qquad ( 43 )$$

with L_{T} and R_{A} denoting the length of the target protein and the set of aligned residues between both. Moreover, d(Eᵢ, Pᵢ) is the 3D distance between the Cα atoms of the ith aligned residue pair, and d₀(L_{T})=1.24 \sqrt{LT−15}−1.8 is a normalization factor accounting for different protein lengths. A TM score value of 0.17 or below is equivalent to random similarity between two structures, whereas a score of about 0.5 or more indicates that both structures have the same fold (Xu (2010) Bioinformatics 26, 889-895). Above 0.5, structural similarity increases super-linearly with increasing TM score values.

In some embodiments, when modeling transmembrane proteins, water-soluble portions of a protein can be excluded by obtaining information about transmembrane segments in experimental structures from the PDBTM database (Tusnady et al. (2005) Nucleic Acids Res. 33 (Database issue), D275-D278) and restricting the structural alignment and score calculation to membrane-integral portions of the protein.

### Calculation of Cumulative EC Scores for Each Residue

To quantify the strength of evolutionary couplings on each residue in each protein, the cumulative strength of ECs per residue over a background model of the full sequence can be calculated. For each residue, the evolutionary constraint coupling strengths ECᵢⱼ obtained from the maximum entropy model can be summed over the first L (length of modeled sequence) high-ranking pairs that a residue is involved in. The score for each residue can then be normalized by the average strength of all residues in the full sequence. For example, where e denotes the list of L top-ranked evolutionary constraints, the cumulative normalized EC strength for a particular residue x is given by

$$ECR ( x ) = \frac{{\sum }_{\{ ( x , j ) ∈ ⋃ ( i , x ) ∈ \}} {EC}_{ij}}{\frac{1}{L} {\sum }_{( i , j ) ∈} {EC}_{ij}} . \qquad ( 44 )$$

All residues with an ECR value greater than one are subject to evolutionary constraints above average.

### Structure-Based Identification of Interaction Partners

Target protein structures generated and/or predicted using methods of the disclosure can be used to identify candidate interaction partners for a target protein. For example, target protein structures can be used for rational design, e.g., by computational techniques that identify possible interaction partners. Suitable techniques are discussed in, e.g., Abagyan, R.; Totrov, M. Curr. Opin. Chem. Biol. 2001, 5, 375-382; Jones et al., Current Opinion in Biotechnology, 6, (1995), 652-656; and Halperin et al. Proteins 2002, 47, 409-443.

In some embodiments, the disclosure provides a computer-based method for analysis of an interaction of a candidate interacting partner with a target protein structure. Generally, such methods can include steps of: providing a target protein structure; providing a plurality of candidate interacting partners to be fitted to the target protein structure; fitting the structure of each of the plurality of candidate interacting partners to the target protein structure; and selecting one or more interacting partners that fit into the target protein structure.

Candidate interaction partners can include, e.g., small molecules and polypeptides. Candidate interaction partners can be designed de novo, known interaction partners (e.g., ligands), or can be identified from databases and/or libraries. In some embodiments, such candidate interacting partners are selected from publicly available databases including, for example, ACD from Molecular Designs Limited; NCI from National Cancer Institute; CCDC from Cambridge Crystallographic Data Center; CAST from Chemical Abstract Service; Derwent from Derwent Information Limited; Maybridge from Maybridge Chemical Company LTD; Aldrich from Aldrich Chemical Company; Directory of Natural Products from Chapman & Hall; GenBank, and UniProt.

In some embodiments, the structure of a target protein can be used to generate pharmacophore models for virtual library screening or compound design. Modeling software can be used to determine target protein binding surfaces and to reveal features such as van der Waals contacts, electrostatic interactions, and/or hydrogen bonding opportunities. These binding surfaces can be used to model docking of candidate interacting partners, to arrive at pharmacophore hypotheses, and/or to design candidate interacting partners (e.g., therapeutic compounds) de novo. The term “pharmacophore” refers to a collection of chemical features and three-dimensional structural elements that represent specific characteristics responsible for activity of an interaction partner (e.g., a ligand). A pharmacophore can include surface-accessible features, hydrogen bond donors and acceptors, charged/ionizable groups, and/or hydrophobic patches, among other features.

Pharmacophores can be determined using software such as CATALYST (including HypoGen or HipHop, available from Molecular Stimulations Inc.), CERIUS2, or constructed by hand from a conformation of known interacting partner. A pharmacophore can be used to screen structural libraries using known programs, e.g., CATALYST; CLIX program (Davic & Lawrence, Proteins 12:31-41, 1992); DISCO program (available from Tripos); and/or GASP program (available from Tripos). A binding surface or pharmacophore of a target protein can be used to map favorable interaction positions for functional groups (e.g., protons, hydroxyl groups, amine groups, acidic groups, hydrophobic groups and/or divalent cations) or small molecule fragments. Candidate interacting partners can then be designed de novo in which the relevant functional groups are located in the correct spatial relationship to interact with the target protein.

Several de novo design methods useful for designing candidate interaction partners are known in the art. Nonlimiting examples include: LUDI (Bohm, J. Comp. Aid. Molec. Design, 6, pp. 61-78 (1992); available from Molecular Simulations Incorporated, San Diego, Calif.); LEGEND (Nishibata et al., Tetrahedron, 47, p. 8985 (1991); available from Molecular Simulations Incorporated, San Diego, Calif.); LeapFrog (available from Tripos Associates, St. Louis, Mo.); SPROUT (Gillet et al., J. Comput. Aided Mol. Design, 7, pp. 127-153 (1993); available from the University of Leeds, UK).

A three-dimensional structure of a candidate interaction partner to be fitted to a target protein structure can be modeled in three dimensions using, e.g., commercially available software. “Fitting” as used herein means determining (e.g., by automatic or semi-automatic means) interactions between at least one atom of a candidate interaction partner and at least one atom of a target protein structure, and calculating the extent to which such an interaction is stable. Interactions can include attraction and repulsion, brought about by charge, steric considerations and the like. Various computer-based methods for fitting are available in the art, for example, docking program such as GOLD (Jones et al., J. Mol. Biol., 245, 43-53 (1995); Jones et al., J. Mol. Biol., 267, 727-748 (1997)); GRAMM (Vakser, Proteins, Suppl., 1:226-230 (1997)); DOCK (Kuntz et al., J. Mol. Biol. 1982, 161, 269-288, Makino et al., J. Comput. Chem. 1997, 18, 1812-1825); AUTODOCK (Goodsell et al., Proteins 1990, 8, 195-202, Morris et al., J. Comput. Chem. 1998, 19, 1639-1662); FlexX (Rarey et al., J. Mol. Biol. 1996, 261, 470-489); and ICM (Abagyan et al., J. Comput. Chem. 1994, 15, 488-506). This procedure can include computer fitting of a candidate interaction partner to a target protein structure to ascertain how well the structure of the candidate interaction partner will interact with (e.g., bind to) a target protein.

Once a candidate interaction partner has been designed or selected, the affinity and/or specificity with which that candidate interaction partner may interact with (e.g., bind to) a target protein, or a portion thereof, can be tested and/or optimized by computational evaluation. For example, in some embodiments, a candidate interaction partner can demonstrate a relatively small difference in energy between its bound and free states (i.e., a small deformation energy of binding). A candidate interaction partner can be further computationally optimized so that in its bound state it lacks repulsive electrostatic interaction with the target protein and with any surrounding water molecules. Such non-complementary electrostatic interactions can include repulsive charge-charge, dipole-dipole and charge-dipole interactions.

Specific computer software is available in the art to evaluate compound deformation energy and electrostatic interactions. Nonlimiting examples of such programs include Gaussian (Gaussian, Inc., Wallingford, Conn.); AMBER (University of California at San Francisco, San Francisco, Calif.); QUANTA/CHARMm (Accelrys, San Diego, Calif.); and Discovery Studio® (Accelrys, San Diego, Calif.).

### Combined Methods

Methods of the disclosure can be used alone or in combination with one or more known techniques, such as to enable 3D structures with correct overall fold to be predicted for biologically interesting members of protein families of unknown structure. Such methods can have applications in diverse areas of molecular biology. These include, e.g., accelerated and/or more efficient experimental determination of protein structures by X-ray crystallography and NMR spectroscopy, e.g., by eliminating the need for heavy atom derivatives, by guiding the interpretation of electron density maps or by reducing the required number of experimental distance restraints. Additional applications include, e.g., a survey of the arrangements of transmembrane segments in membrane proteins; discovery of remote evolutionary homologies by comparison of 3D structures beyond the power of sequence profiles; prediction of the assembly of domain structures and protein complexes; plausible structures for alternative splice forms of proteins; functional alternative conformers in cases where the methods generate several distinct sets of solutions consistent with the entire set of derived constraints; generation of hypotheses of protein folding pathways if the DI predictions involve residue pairs strategically used along a set of folding trajectories; and to prioritize protein targets and define domains of interest for both crystallography and NMR analyses.

In some embodiments, methods of the disclosure (and/or information from methods of disclosure) can be combined with information from structural biology experiments (e.g., X-ray crystallography or NMR). In some embodiments, the combination (e.g., “hybrid methods”) can determine high-accuracy structures. In some embodiments, hybrid methods achieve high-accuracy structures relatively rapidly (e.g., faster as compared with known methods). For example, information (e.g., distance constraints) and/or structures generated using methods of the disclosure can be combined with a native dataset from X-ray crystallography (e.g., before final solution of the structures) to inform the determination of X-ray crystallography structures. In some embodiments, information (e.g., distance constraints) and/or structures generated using methods of the disclosure can be combined with data from NMR experiments (e.g., NOE distance constraints from NMR experiments, NMR backbone chemical shifts, and/or sparse NMR-derived distance constraints). The methods of the disclosure are useful to accelerate structural genomics.

### Networks

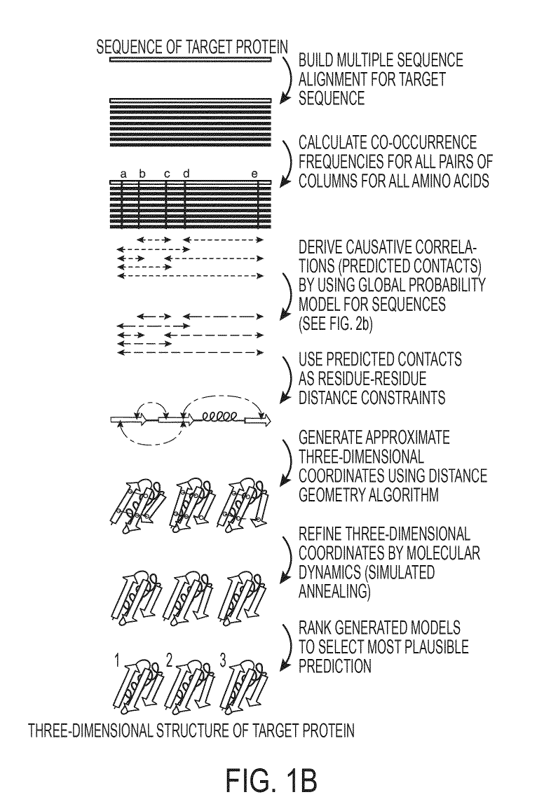

Various computing network and computing devices are known in the art and can be used to practice the present invention. FIG. 2 depicts an apparatus 200, according to an illustrative embodiment of the invention, for predicting 3D structure of a protein from its sequence. The system 200 includes a client node 204, a server node 208, a database 212, and, for enabling communications therebetween, a network 216. As illustrated, the server node 208 may include an analysis module 220.

The network 216 may be, for example, a local-area network (LAN), such as a company or laboratory Intranet, a metropolitan area network (MAN), or a wide area network (WAN), such as the Internet. Each of the client node 204, server node 208, and database 212 may be connected to the network 216 through a variety of connections including, but not limited to, standard telephone lines, LAN or WAN links (e.g., T1, T3, 56 kb, X.25), broadband connections (e.g., ISDN, Frame Relay, ATM), or wireless connections. The connections, moreover, may be established using a variety of communication protocols (e.g., HTTP, TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g, and direct asynchronous connections).

The client node 204 may be any type of personal computer, Windows-based terminal, network computer, wireless device, information appliance, RISC Power PC, X-device, workstation, mini computer, main frame computer, personal digital assistant, set top box, handheld device, or other computing device that is capable of both presenting information/data to, and receiving commands from, a user of the client node 204 (e.g., a laboratory technician). The client node 204 may include, for example, a visual display device (e.g., a computer monitor), a data entry device (e.g., a keyboard), persistent and/or volatile storage (e.g., computer memory), a processor, and a mouse. In one embodiment, the client node 204 includes a web browser, such as, for example, the INTERNET EXPLORER program developed by Microsoft Corporation of Redmond, Wash., to connect to the World Wide Web.

For its part, the server node 208 may be any computing device that is capable of receiving information/data from and delivering information/data to the client node 204, for example over the network 216, and that is capable of querying, receiving information/data from, and delivering information/data to the database 212. For example, as further explained below, the server node 208 may query the database 212 for a set of background-subtracted data, receive the data therefrom, process and analyze the data, and then present one or more results of the analysis to the user at the client node 204. The set of background-subtracted data may correspond, for example, to an encoded bead multiplex assay for a plurality of patient samples run in parallel. The server node 208 may include a processor and persistent and/or volatile storage, such as computer memory.

The database 212 may be any repository of information (e.g., a computing device or an information store) that is capable of (i) storing and managing collections of data, such as the background-subtracted data, (ii) receiving commands/queries and/or information/data from the server node 208 and/or the client node 204, and (iii) delivering information/data to the server node 208 and/or the client node 204. For example, the database 212 can be any information store storing the files output by an instrument used in a laboratory, whether that be a computer memory onboard the instrument itself or a separate information store to which the output files of the instrument have been transferred. The database 212 may communicate using SQL or another language, or may use other techniques to store, receive, and transmit data.

The analysis module 220 of the server node 208 may be implemented as any software program and/or hardware device, for example an application specific integrated circuit (ASIC) or a field programmable gate array (FPGA), that is capable of providing the functionality described below. It will be understood by one having ordinary skill in the art, however, that the illustrated analysis module 220, and the organization of the server node 208, are conceptual, rather than explicit, requirements. For example, the single analysis module 220 may in fact be implemented as multiple modules, such that the functions performed by the single module, as described below, are in fact performed by the multiple modules.

Although not shown in FIG. 2, each of the client node 204, the server node 208, and the database 212 may also include its own transceiver (or separate receiver and transmitter) that is capable of receiving and transmitting communications, including requests, responses, and commands, such as, for example, inter-processor communications and networked communications. The transceivers (or separate receivers and transmitters) may each be implemented as a hardware device, or as a software module with a hardware interface.

It will also be understood by those skilled in the art that FIG. 2 is a simplified illustration of the system 200 and that it is depicted as such to facilitate the explanation of the present invention's embodiments. Moreover, the system 200 may be modified in a variety of manners without departing from the spirit and scope of the invention. For example, the server node 208 and/or the database 212 may be local to the client node 204 (such that they may all communicate directly without using the network 216), the database 212 may be local to the server node 208, or the functionality of the server node 208 and/or the database 212 may be implemented on the client node 204 itself (e.g., the analysis module 220 and/or the database 212 may reside on the client node 204 itself). As such, the depiction of the system 200 in FIG. 2 is non-limiting.

The section headings used herein are for organizational purposes only and are not to be construed as limiting the subject matter described in any way.

### EXAMPLES

### Example 1

### Prediction of Three-Dimensional Structures of Membrane Proteins

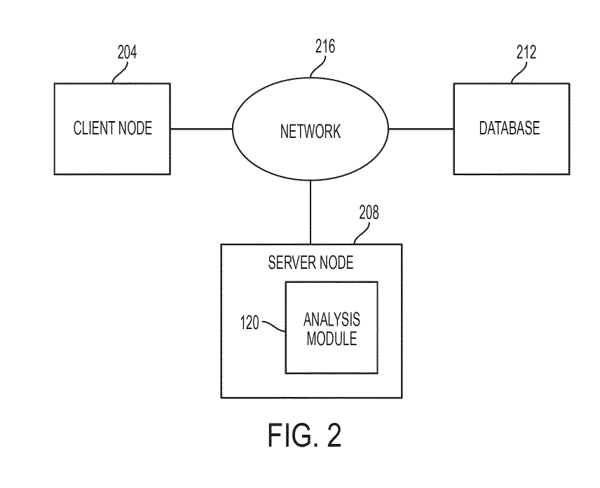

Reported here is the development and use of a method, EVfold membrane, which enables de novo prediction of 3D structures of unknown α-helical transmembrane proteins from evolutionary constraints, using neither fragments, threading, nor homologous 3D structures. The structures of 11 transmembrane proteins of unknown structure were predicted, including six pharmacological targets (FIG. 3, Table 1). To verify that predicted structures were plausible, the structures of a diverse set of 25 transmembrane proteins with known 3D structures (Table 1) were predicted using EVfold membrane, and an unprecedented level of agreement was found with the cognate crystal structures (TM scores>0.5 for 22 out of 25 of the benchmarked proteins). Functionally important regions of each protein were more accurately predicted than the protein as a whole, and residues that are subject to multiple pair constraints tended to be in substrate binding pockets, oligomerization interfaces, and/or involved in conformational changes.

### Selection of Candidate Sets of Membrane Proteins

To test the ability of the folding protocol to predict the 3D structure of membrane proteins, a non-redundant set of proteins was compiled from UniProt (UniProt Consortium (2012) Nucleic Acids Res. 40 (Database issue), D71-D75) with solved structures in the PDB (Berman et al. (2000) Nucleic Acids Res. 28, 235-242), based on a listing of membrane proteins given by the Membrane Proteins of Known 3D Structure database (Jayasinghe et al. (2001) Protein Sci. 10, 455-458). Initial criteria for inclusion in the set were that the protein must have at least five transmembrane helices and 2*L (length of protein) homologous sequences in UniProt. Diversity of the candidate set was ensured by choosing only proteins belonging to different Pfam (Punta et al. (2012) Nucleic Acids Res. 40 (Database issue), D290-D301) protein families, and in most cases also to different Pfam clans. In some cases, this set was further extended by other members from the same Pfam family (e.g., different Rhodopsin-like GPCRs). If more than one crystal structure was available for a certain protein, the crystal structure was chosen having the highest resolution and number of residues covered by the structure relative to the UniProt sequence.

The set of proteins of unknown structure was created by selecting medically important transmembrane proteins from DrugBank (Knox et al. (2011) Nucleic Acids Res. 39 (Database issue), D1035-D1041), using a mapping provided by the CAMPS 2.0 database (Neumann et al. (2012) Proteins 80, 839-857). Each candidate protein was first examined for membership in Pfam families without known structure, before verifying the absence of homologous structures with an HHblits (Remmert et al. (2012) Nat. Methods 9, 173-175) search against the PDB. This set was extended with additional candidates of particular biological interest obtained from a non-exhaustive screening of Pfam families. As with the known structures, at least five transmembrane helices and a sufficient number of homologous sequences were required for inclusion in the candidate set. In most cases, the canonical UniProt sequence was selected as starting point for the prediction protocol. In some cases, however, it was necessary to remove parts of the query sequence as homology searches could be misled by the presence of multiple domains in the same sequence (e.g., globular ATP-binding domain of ABC transporters). This removal was performed blindly based on transmembrane topology prediction and Pfam domain assignments.

### Multiple Sequence Alignments

For each candidate protein, several multiple sequence alignments were generated using the HHblits software suite for remote homology detection by HMM-HMM comparison (Remmert et al. (2012) Nat. Methods 9, 173-175) on a preclustered HMM version of the UniProt protein sequence database (UniProt Consortium (2012) Nucleic Acids Res. 40 (Database issue), D71-D75) (version 2 Sep. 2011). Homology searches were performed with 2 iterations (-n 2) and E-value thresholds (1E-03, 1E-05, 1E-10, 1E-15, 1E-20, 1E-30, 1E-40) were varied to search across alignment diversity. After each iteration, all previously found database HMMs were realigned to the query sequence using the HHblits MAC algorithm to ensure maximum alignment accuracy (-realignoldhits and -realign_max parameters). In the alignment output step, all filtering of sequences based on pairwise sequence identities (-id 100 and -nodiff parameters) was disabled to include the full set of homologous sequences contained in the database. By construction, the resulting alignment was based around the HMM of the query sequence. This meant that all residues in the query sequence corresponded to an HMM match state (upper-case residue column in the alignment), while insertions relative to the query were represented by unaligned insert state columns (lower-case residue columns in alignment). Despite being an upper-case column, only a fraction of sequences might have alignable residues in that column whereas the majority of sequences could have a deletion relative to the query sequence. Yet, the algorithm for inference of residue coevolution made use of gap frequencies in match state columns. To avoid potential false correlations arising from gaps and assuming isostructuralism of all aligned sequences, a match state reassignment was performed using the reformat.pl script from the HHblits suite. As a default, a conservative threshold was chosen of a maximum of 30% gaps for the residues to remain upper-case in that column. After reassigning match state columns, for each of the alignments generated at a different E-value threshold, the number of upper-case columns and the number of sequences in the alignment were recorded. The alignment giving the best trade-off between the number of included sequences and predicted transmembrane region coverage with match state columns was chosen for the inference of coevolving residue pairs. For some proteins, sufficient coverage of the transmembrane part of the query sequence was not obtained with this conservative strategy due to a high number of homologous sequence fragments in UniProt. In that case, the allowed amount of gaps in an upper-case column was blindly increased to reach sufficient coverage of the transmembrane part.

### Positive Control Experiments

To test how well the membrane proteins were able to be reconstructed if all the constraints were true positives, 3D models were reconstructed using known contacts implemented in a protocol identical to those used with the predicted contacts. This imposed an upper bound on the maximum possible accuracy using the method. Using all pairs of residues in an experimental protein structure which had at least one pair of atoms closer than 5 Å, idealized distance restraints on the corresponding Cα, Cβ and side chain atoms were generated. In these controls, in contrast to the predicted sets, secondary structure information was used from the known 3D structure, extracted using DSSP (Kabsch et al. (1983) Biopolymers 22, 2577-2637). The eight secondary structure states output by DSSP were reduced to three states (helix, sheet, coil) (Rost et al. (1993) J. Mol. Biol. 232, 584-599) and from this three-state representation, both idealized distance and dihedral angle restraints were generated. A set of 20 models were predicted using identical parameters for CNS distance geometry, simulated annealing and energy minimization, as the original experimental structure to assess accuracy.

### Prediction of Unknown 3D Structures of α-Helical Transmembrane Proteins

A survey of targets in the DrugBank database (Knox et al. (2011) Nucleic Acids Res. 39 (Database issue), D1035-D1041) for transmembrane proteins together with large families from the CAMPS (Neumann et al. (2012) Proteins 80, 839-857) yielded 18 nonredundant families with >1,000 sequences, with ≧5 predicted transmembrane helices, and without a known 3D structure for any family member. Eleven of these targets were selected for detailed analysis, covering diverse sizes and functional types, with several of the families having more than one drug target (Table 1).

TABLE 1
Predicted Proteins of Known and Unknown Experimental Structure

| Uniprot Name | | | | Model | | | | | | | | |
|---|---|---|---|---|---|---|---|---|---|---|---|---|
| Known Structure | Length | TMH^{a} | E-val^{b} | Length | #Seq^{c} | Top #^{d} | TM^{e} | Cα-rmsd^{f} | Best #^{d} | TM^{e} | Cα-rmsd^{f} | PDB^{g} |
| ADIC_SALTY | 445 | 12 | E-20 | 394 | 24284 | 240_15 | 0.67 | 4.2 (300) | 240_15 | 0.67 | 4.2 (300) | 3ncyA |
| ADRB2_HUMAN | 413 | 7 | E-20 | 296 | 35593 | 160_5 | 0.67 | 3.3 (201) | 160_5 | 0.67 | 3.3 (201) | 2rh1A |
| ANT1_BOVIN | 298 | 6 | E-40 | 285 | 9828 | 200_20 | 0.48 | 3.8 (136) | 270_17 | 0.51 | 4.0 (152) | 1okcA |
| AMTB_ECOLI | 428 | 10 | E-5 | 396 | 4407 | 270_17 | 0.67 | 3.9 (262) | 280_5 | 0.67 | 3.6 (260) | 1xqfA |
| AQP4_HUMAN | 323 | 6 | E-10 | 215 | 6469 | 80_19 | 0.50 | 2.9 (100) | 100_14 | 0.51 | 3.4 (110) | 3gd8A |
| BTUC_ECOLI | 326 | 10 | E-10 | 299 | 12926 | 250_19 | 0.67 | 3.2 (209) | 250_19 | 0.67 | 3.2 (209) | 1l7vA |
| C3NQD8_VIBCJ | 461 | 12 | E-20 | 431 | 13864 | 250_11 | 0.62 | 4.6 (306) | 290_8 | 0.63 | 4.3 (305) | 3mktA |
| C6E9S6_ECOBD | 485 | 14 | E-10 | 412 | 63730 | 180_9 | 0.63 | 4.2 (299) | 180_9 | 0.63 | 4.2 (299) | 3rkoN |
| COX1_BOVIN | 514 | 12 | E-40 | 486 | 73822 | 150_6 | 0.66 | 4.5 (360) | 150_11 | 0.66 | 4.4 (354) | 1occA |
| COX3_BOVIN | 261 | 7 | E-3 | 182 | 10705 | 50_9 | 0.69 | 2.8 (151) | 50_9 | 0.69 | 2.8 (151) | 1occC |
| CYB_BOVIN | 379 | 8 | E-3 | 335 | 43891 | 120_4 | 0.58 | 4.1 (203) | 100_9 | 0.64 | 3.7 (231) | 1pp9B |
| FIEF_ECOLI | 300 | 6 | E-5 | 197 | 9722 | 200_10 | 0.59 | 2.8 (119) | 40_7 | 0.63 | 2.8 (131) | 3h90A |
| GLPG_ECOLI | 276 | 6 | E-5 | 169 | 5263 | 120_11 | 0.64 | 2.6 (126) | 120_11 | 0.64 | 2.6 (126) | 3b45A |
| GLPT_ECOLI | 452 | 12 | E-30 | 402 | 24912 | 330_12 | 0.67 | 3.8 (283) | 330_13 | 0.67 | 4.0 (297) | 1pw4A |
| METI_ECOLI | 217 | 6 | E-15 | 206 | 30400 | 120_17 | 0.46 | 3.5 (93) | 120_6 | 0.48 | 3.4 (94) | 3dhwA |
| MIP_BOVIN | 263 | 6 | E-10 | 212 | 6468 | 150_12 | 0.55 | 3.1 (116) | 130_20 | 0.58 | 2.9 (124) | 1ymgA |
| MSBA_SALTY | 330 | 6 | E-3 | 310 | 29034 | 100_12 | 0.57 | 3.3 (180) | 110_12 | 0.61 | 3.5 (208) | 3b60A |
| O67854_AQUAE | 513 | 12 | E-3 | 463 | 4500 | 280_4 | 0.55 | 5.1 (274) | 170_20 | 0.58 | 4.8 (286) | 2a65A |
| OPSD_BOVIN | 348 | 7 | E-20 | 274 | 35901 | 110_16 | 0.70 | 3.3 (214) | 110_16 | 0.70 | 3.3 (214) | 1hzxA |
| Q87TN7_VIBPA | 485 | 8 | E-10 | 407 | 4097 | 270_12 | 0.59 | 4.0 (242) | 260_19 | 0.60 | 4.2 (258) | 3pjzA |
| Q8EKT7_SHEON | 516 | 12 | E-10 | 447 | 12063 | 100_14 | 0.40 | 4.6 (160) | 240_19 | 0.43 | 4.8 (183) | 2xutA |
| Q9K0A9_NEIMB | 315 | 10 | E-10 | 297 | 4244 | 270_9 | 0.44 | 3.6 (131) | 120_9 | 0.49 | 3.9 (138) | 3zuxA |
| SGLT_VIBPA | 543 | 14 | E-5 | 487 | 9563 | 310_11 | 0.49 | 4.6 (214) | 340_10 | 0.53 | 4.8 (264) | 2xq2A |
| TEHA_HAEIN | 328 | 10 | E-3 | 304 | 1861 | 70_15 | 0.51 | 4.1 (154) | 210_17 | 0.56 | 4.0 (175) | 3m71A |
| URAA_ECOLI | 429 | 14 | E-3 | 393 | 14992 | 250_12 | 0.50 | 4.8 (194) | 250_5 | 0.50 | 4.5 (189) | 3qe7A |
| Unknown Structure | | | | | | | Structural Similarity to | | | Z^{h} | Cα-rmsd^{f} | PDB^{g} |
| ADR1_HUMAN | 375 | 7 | E-5 | 223 | 3410 | 150_14 | bacteriorhodopsin | | | 12 | 4.5 (204) | 3haoA |
| NU1M_HUMAN | 318 | 8 | E-10 | 282 | 17558 | 210_18 | mit. complex 1 subunit L | | | 10 | 5.0 (170) | 3rkoL |
| S22A4_HUMAN | 551 | 12 | E-30 | 373 | 21704 | 220_11 | L-fucose permease FucP | | | 10 | 6.0 (267) | 3o7qA |
| ABCG2_HUMAN | 655 | 7 | E-10 | 274 | 5404 | 210_3 | | | | | | |
| ELOV4_HUMAN | 314 | 7 | E-3 | 233 | 1436 | 190_6 | | | | | | |
| SL9A1_HUMAN | 815 | 13 | E-10 | 367 | 6020 | 210_17 | acriflavine res. prot. AcrB | | | 4 | 4.7 (165) | 2gifA |
| MSMO1_HUMAN | 293 | 5 | E-20 | 220 | 897 | 70_13 | | | | | | |
| S13A1_HUMAN | 595 | 15 | E-20 | 543 | 1836 | noneⁱ | | | | | | |
| EAMA_ECOLI | 299 | 10 | E-5 | 276 | 31753 | 250_10 | | | | | | |

| | | | | | | | | | | |
|---|---|---|---|---|---|---|---|---|---|---|
| LIVH_ECOLI | 308 | 8 | E-3 | 282 | 23968 | 230_16 | permease protein BtuC | 6 | 4.1 (140) | 1l7vA |
| GABR1_HUMAN | 961 | 7 | E-5 | 298 | 2871 | 190_19 | β2 adrenergic receptor | 6 | 6.0 (191) | 3p0gA |

^{a}Number of transmembrane helices.
^{b}E value for HHblits sequence search.
^{c}Number of sequences in multiple sequence alignment.
^{d}Number of evolutionary constraints used and model number of blind top-ranked and best-generated model, respectively.
^{e}TM score.
^{f}Cα; root-mean-square deviation in Å.
^{g}Accession code and chain of similar PDB structure.
^{h}DALI Z score.
ⁱNo model looks plausible (large protein, few sequences).

Coordinates for the remaining seven families are available at http://evfold.org/transmembrane. These proteins are implicated in many diseases, including diabetes, obesity, Crohn's disease, breast cancer, Leber hereditary optic neuropathy, Alzheimer's disease, and Parkinson's disease. 400-600 all-atom 3D models were predicted for each protein according to the Maximum Entropy methods described herein.

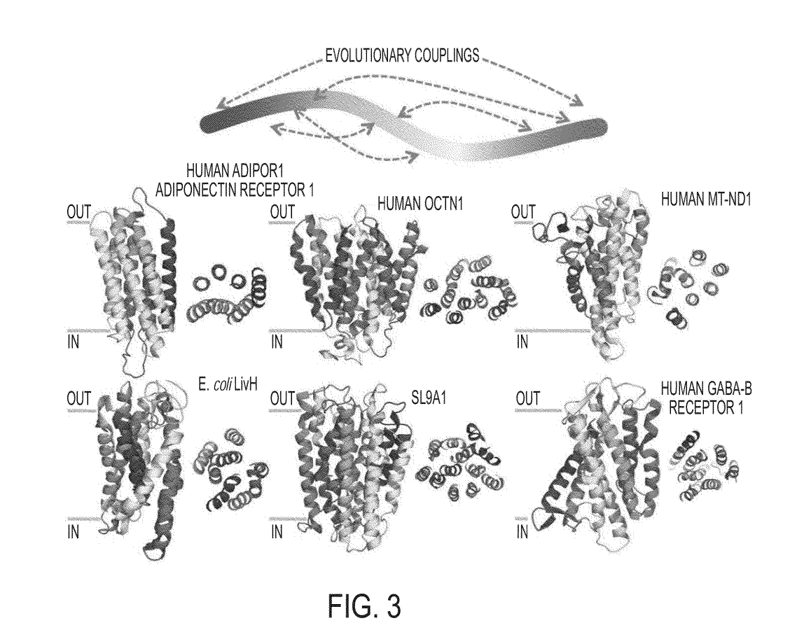

The predicted structures of five of the proteins had similar folds to other known 3D membrane protein structures (FIG. 4C) despite negligible sequence similarity, a recurring theme seen in structural genomics and earlier work (Holm et al. (1993) J. Mol. Biol. 233, 123-138; Murzin (1993) EMBO J. 12, 861-867). Predicted structures of three membrane proteins showed some structural similarities to those of other sequence-distant members of the same PFAM clan. A search against all known 3D structures with the top-ranked model of the human OCTN1, a 12 helical transporter sugar transporter, yielded several significant hits to structures in the major facilitator superfamily (FIGS. 3 and 4C and Table 1), including FucP (PDB: 3o7q; Dang et al. (2010) Nature 467, 734-738) and GlpT (PDB: 1pw4; Law et al. (2008) J. Mol. Biol. 378, 828-839). FucP and GlpT sequences were not in our alignment and have only 10% and 7% sequence identity to OCTN1, respectively, below the level allowing inference of structural homology. Similarly, the 8 transmembrane helical E. Coli LIVH, a high-affinity leucine transporter, is structurally similar to the bacterial B12 uptake protein BtuC (PDB: 117v; Locher et al. (2002) Science 296, 1091-1098) despite only 8% sequence identity between the proteins (Table 1).

Third, the predicted structures of the GABA receptor 1, a protein involved in synaptic inhibition and a pharmacological target, are structurally similar to other GPCRs despite a negligible sequence identity (10%) (FIG. 3 and Table 1). In the predicted models of the GABA receptor, a lack of well-ordered structure formed by the extracellular loops and a lack of β sheet formation by the predicted β strands indicate potential model errors. Nevertheless, high-scoring predicted residue pair interactions in the extracellular region, specifically between loops 2/3 and 3/4, are located close to the putative extracellular ligand-binding domain.

The five top-ranked predicted adiponectin receptor 3D structures were surprisingly similar (about 4.5 Å Cα-rmsd over 204 residues) to the bacteriorhodopsin crystal structure (PDB: 3hao), with highly significant Dali (Holm et al. (1995) Trends Biochem. Sci. 20, 478-480) Z scores between 7 and 13, despite negligible sequence identity (8%) (FIGS. 3 and 4C). Although adiponectin receptor is a 7 transmembrane protein, it was not previously thought to have structural or functional similarity to G protein-coupled receptors and is inverted with respect to the membrane (Yamauchi et al. (2003) Nature 423, 762-769).

Significant structural similarity of predicted structures of the human MT-ND 1 subunit to the recently solved structure of one of the major membrane subunits of respiratory complex I (E. coli, 3rko-C; NuoL subunit) (Efremov et al. (2011) Nature 476, 414-420) was also found. Again, the sequences of MT-ND1 and the NuoL subunit are unrelated, with <8% identity. However, high topological similarity was not found to the coarse grained model of the bacterial NuoL subunit (homologous to MT_ND1), which was solved at low resolution without residue assignment (Efremov et al. (2010) Nature 465, 441-445), and the NuoL subunit is almost double the size of our modeled protein. Nevertheless, our MT-ND1 structures overlaid optimally on precisely the regions of bacterial subunits that are structurally duplicated within each protein (in NuoL, TM helices 3-7 and 8-15), further supporting the idea that this is a repeating structural evolutionary module (Efremov et al. (2011) Nature 476, 414-420). Because these mitochondrial subunits are functionally related and spatially coincident throughout evolution, the structural relationship between them may plausibly result from divergent evolution of the sequence. Taken together, these examples of structural relationships between the predicted models and the structures of functionally related but sequence-distant proteins provide support for the accuracy of the de novo prediction.

### Blinded Prediction of Known 3D Structure Transmembrane Proteins

To evaluate the performance of the prediction protocol, the 3D structures were computed of α-helical membrane proteins of known structure from the proteins' sequences alone, i.e., ignoring all aspects of known 3D structures, including sequence-similar fragments. All α-helical membrane proteins from all Pfam families that have >1,000 sequences, sufficient sequence coverage, and more than 4 helices were selected. This resulted in a set of 25 membrane proteins with up to 487 residues (up to 14 transmembrane helices) in 23 structurally diverse families. This set included the human β2 adrenergic receptor (GPCR family), the S. typhimurium arginine/agmatine antiporter ADIC (amino acid/polyamine transporter superfamily), and the E. coli glycerol-3-phosphate transporter (GlpT; major facilitator superfamily) (Table 1).

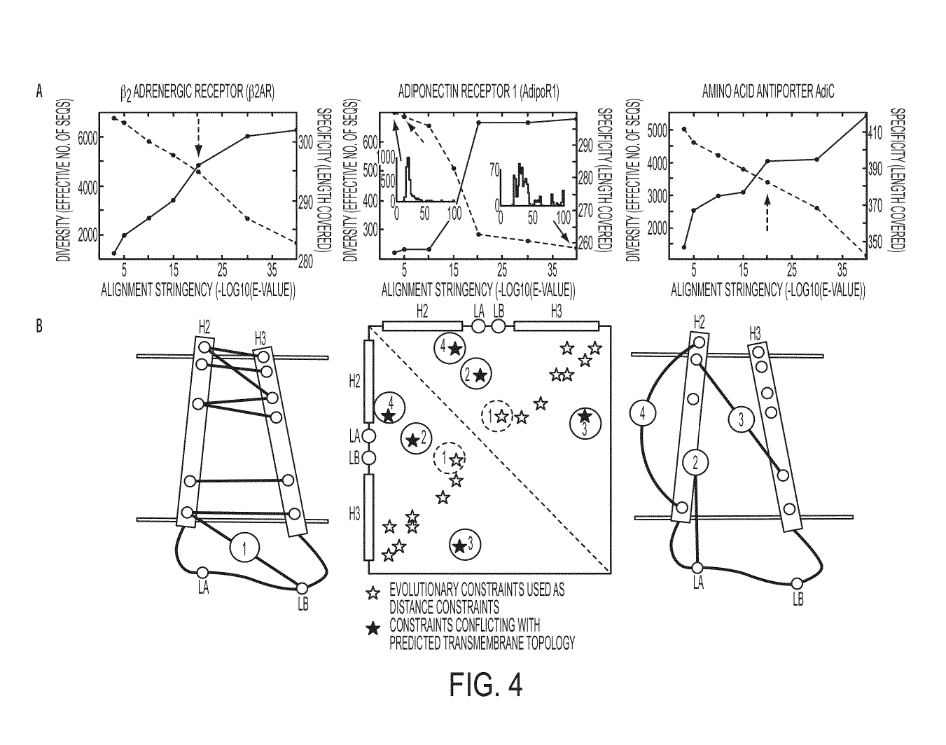

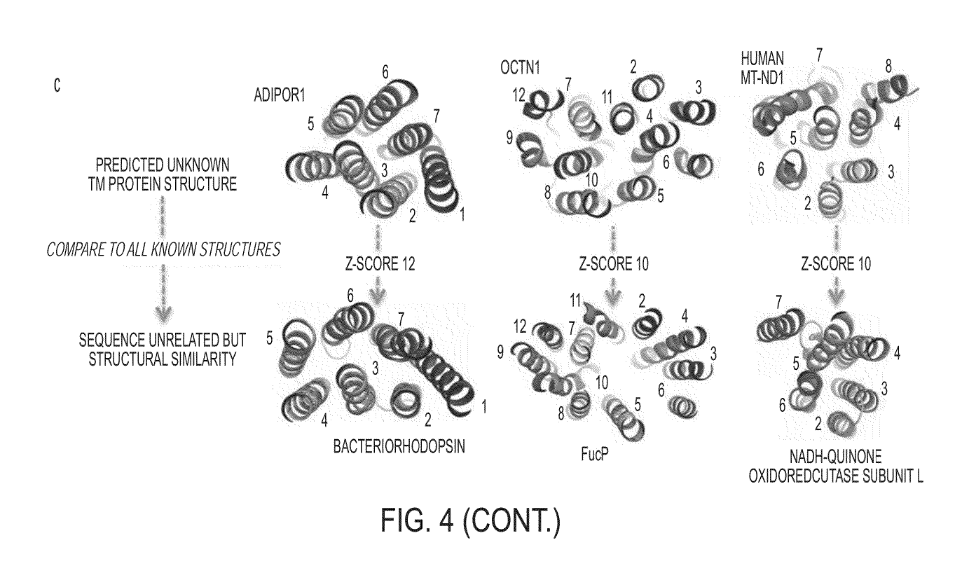

The EVfold membrane protocol provided a ranked set of predicted structures for each protein, which were then compared to a cognate crystal structure. The combined score used for ranking the generated models reliably identified structures of high accuracy and, in some cases, even the best model in the top ten (Table 1). Overall, 21 of the test set of 23 diverse α-helical transmembrane proteins were reliably predicted, with template modeling (TM) scores of 0.5-0.7 and Cα-rmsd 2.6-4.8 Å over >70% of the length (FIGS. 5A and 5B and Table 1). Template modeling score (range 0.0-1.0) is considered reasonable when >0.5 and is comparable across proteins of varying lengths (Zhang et al. (2004) Proteins 57, 702-710). This blindly predicted set allowed assessment of the relationship between the number of evolutionary constraints that were not spatially close in the cognate crystal structure (false positives) and the accuracy of the 3D structure prediction. The highest-ranked evolutionary constraints (1-20) contained about 2% false positives, and the proportion of true positives decreased monotonically as a function of the number of constraints (FIG. 6). However, the accuracy of folding, as measured by TM score, was remarkably robust to variation in the proportion of true positives and was stable over many different folding experiments in which the number of constraints was steadily increased (FIG. 5C). Details of the distribution of predicted contacts along the protein chain and the precise nature of false positives, such as mutual effective cancellation, may have contributed to this robustness.

Known approaches for de novo folding are based primarily on searching for sequence-similar fragments in 3D structure databases followed by fragment assembly using specially designed empirical force fields. The key limitation is the enormous size of the conformational search space. The novel methods described herein overcome this limitation by using the information in the evolutionary constraints and its direct translation to 3D coordinates via distance geometry translates, leading to a considerable performance advantage relative to earlier methods. The advantages are apparent in terms of (1) protein size range, (2) prediction accuracy, (3) efficiency of conformational search, and (4) lack of dependence on fragments and helix-helix contacts from previously solved 3D structures.

More than 50% of membrane proteins have 8-14 transmembrane helices. Models of proteins with up to 14 helices were generated in this Example. Given that no deterioration of accuracy was seen with size (up to almost 500 residues) and accurate 3D folds were obtained with as little as one constraint per residue over the entire size range, this method allows prediction of even larger membrane proteins. To compare accuracy, structures were predicted for five of the same proteins predicted by Barth et al. (Proc. Natl. Acad. Sci. USA 106, 1409-1414 (2009)). Our method reached the threshold coordinate accuracy of 4 Å over comparable or significant larger regions (e.g., 89% rather than 40% of residues for bovine rhodopsin), and it explored conformational search space more efficiently (e.g., around 500 candidate models compared to 200,000 generated in Barth et al. (Proc. Natl. Acad. Sci. USA 106, 1409-1414 (2009)). As a result of this efficiency gain, EVfold all-atom models can be generated on a laptop in a few minutes per structure, without the need for supercomputers. A possible conceptual and practical advantage of the EVfold membrane method is information about the roles of residues and residue interactions in protein function as a result of extracting coupling information at the protein level filtered through functional selection over a myriad of evolutionary experiments.

In general, the accuracy of the predicted model increases with the number of sequences in the alignment normalized for the length of the protein (FIG. 5B). For instance, the predicted structures of two proteins, a proton/peptide symporter and a bile acid symporter, had the lowest TM scores (0.4-0.5) compared to their cognate crystal structures and had among the lowest number of sequences per residue in their input alignments. Conversely, the predicted structure of bovine rhodopsin had 131 sequences per residue and an excellent TM score of 0.7.

### Evolutionary Constraints Include Homo-Oligomer Contacts

Not all residue interactions that are strongly constrained by evolution are close in the 3D structure of the monomeric protein. Residue pairs close in transmembrane protein homo-oligomers may thus appear in conflict with other monomer constraints and/or the predicted 3D fold.

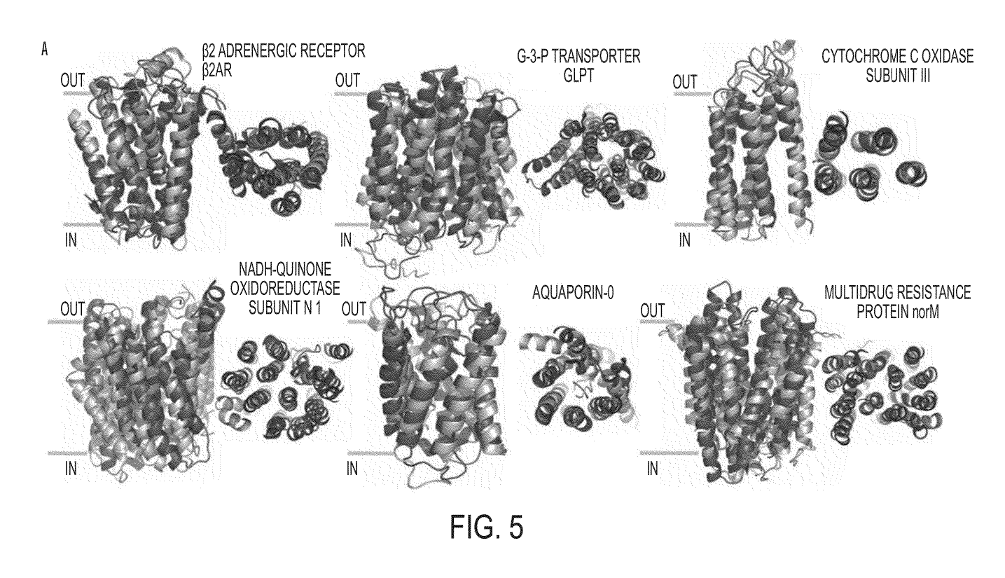

For example, in the computed structure of the ABC transporter S. typhimurium MsbA (FIG. 7A), evolutionary couplings between transmembrane helix 2 and transmembrane helices 5 and 6 were false positives with respect to monomer structure but true positives with respect to the crystal structure dimer interface (PDB: 3b60; Ward et al. (2007) Proc. Natl. Acad. Sci. USA 104, 19005-19010). Similarly, E. coli MetI has a cluster of evolutionary couplings with residues that are not in contact in the monomer but form contacts in the dimer (PDB: 3dhw; Kadaba et al. (2008) Science 321, 250-253). Removal of the conflicting oligomer evolutionary couplings from the folding calculation improved the accuracy of prediction for the monomers for MsbA and MetI (data not shown).

Oligomer contacts were also predicted for proteins of unknown 3D structures, such as AdipoR1. To identify potential dimerization contacts, some evolutionary constraints were observed to be inconsistent with the monomer predicted structure and may therefore be involved in the putative dimerization interface. Interpreting these evolutionary constraints as distance constraints between residues in two separate monomer structures showed that the AdipoR1 dimer interface involves contacts between the loop from helices 4 to 5 and both helices 1 and 7 (FIG. 7B). Consistent with this prediction of the dimerization region are reported observations that mutations in the GXXXG motif on transmembrane helix 5 of AdipoR1 disrupt dimerization (Kosel et al. (2010) J. Cell Sci. 123, 1320-1328). Q335 on the transmembrane helix 7 was unusually strongly constrained, in spite of a low 19% conservation level as a single residue, as a partner in more than 11 evolutionary couplings, some of which may be across this putative interface (FIG. 7B). These examples suggest that homo-oligomer contact detection using evolutionary coupling pairs may yield valuable testable information.

### Evolutionary Constraints Reflect Conformational Change

Many proteins can adopt different distinct conformations as part of their function (Tokuriki et al. (2009) Science 324, 203-207). Whether extracting and analyzing evolutionary couplings from one set of protein sequences could correctly predict more than one 3D conformation of a protein was assessed by analyzing known structures and genuine prediction. GlpT and OCTN1 belong to the functionally diverse subfamilies of the large major facilitator superfamily, secondary membrane transporters that move substrate across the membrane by alternating between two alternative conformations of the channel—one open to the cytoplasm and the other open to the periplasm or extracellular space (Boudker et al. (2010) Trends Pharmacol. Sci. 31, 418-426; Huang et al. (2003) Science 301, 616-620).

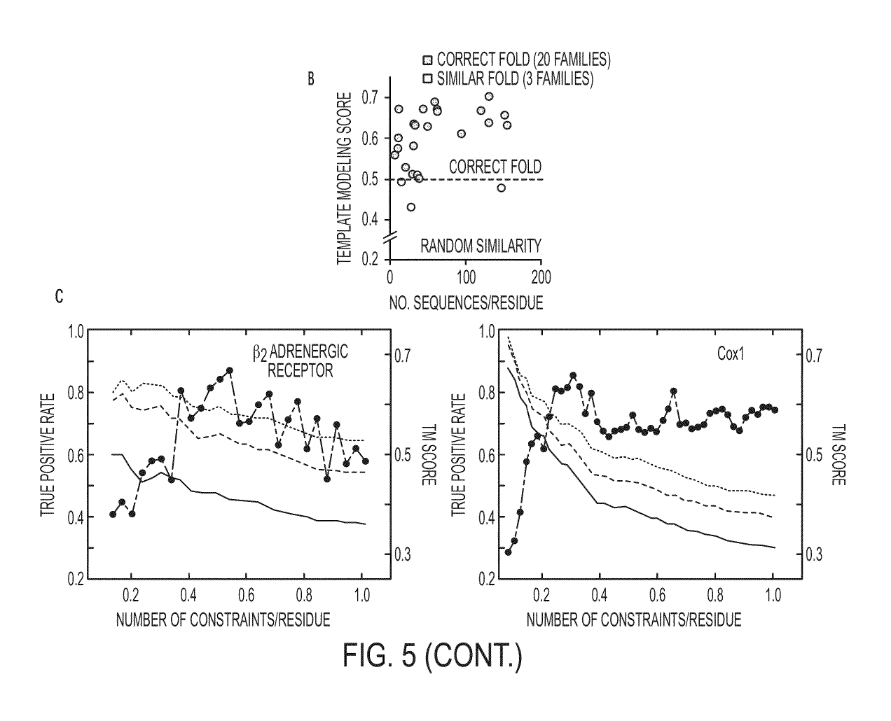

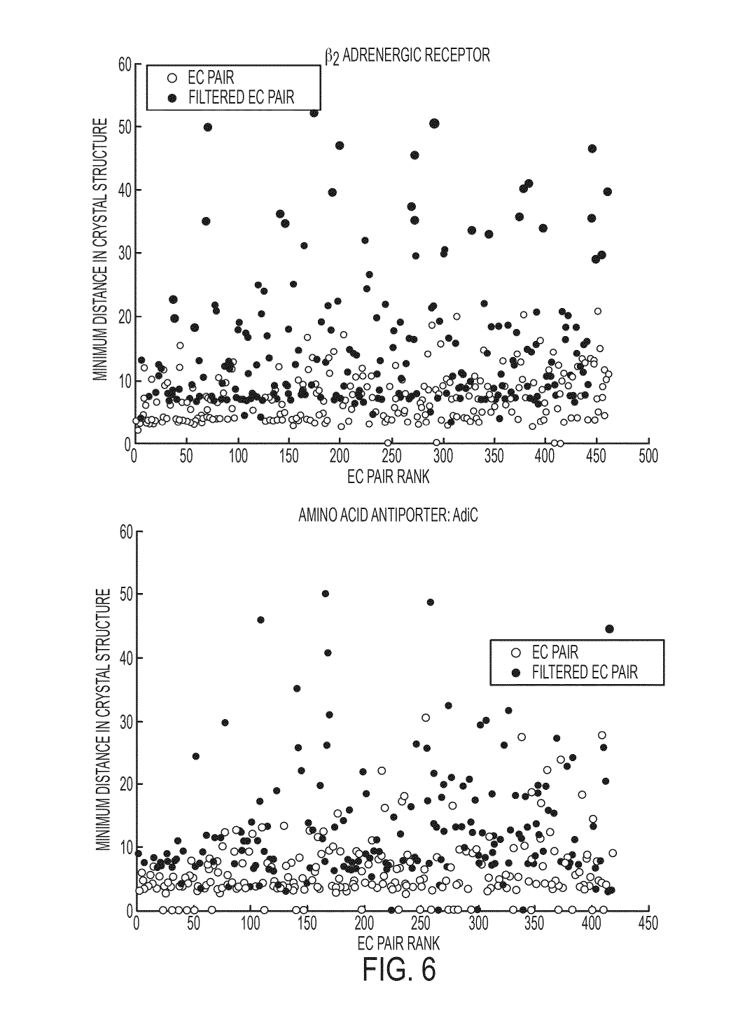

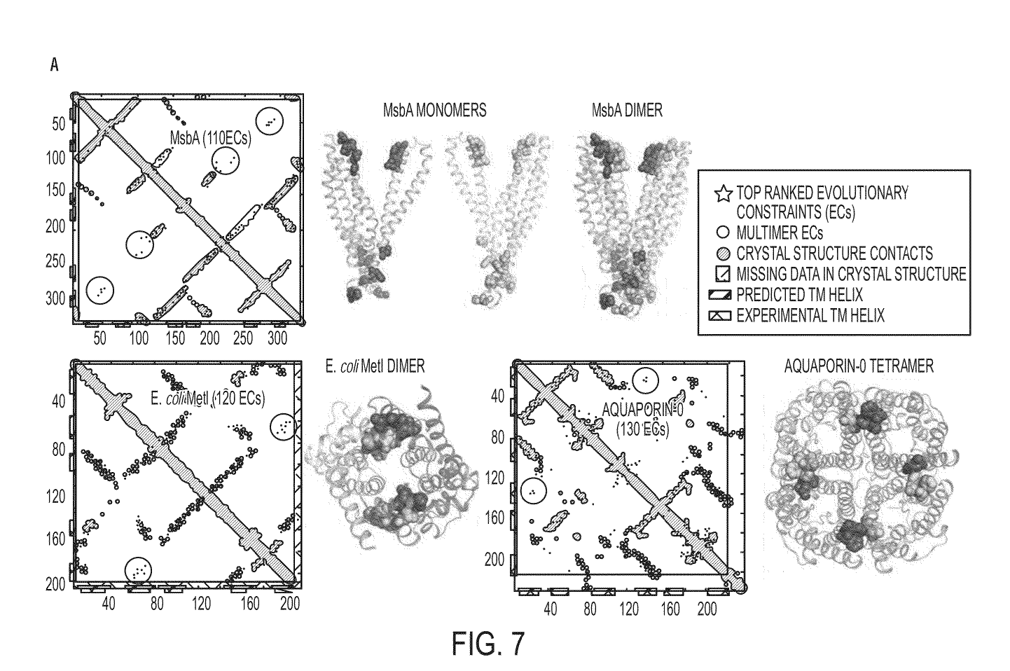

Using the membrane topology prediction for GlpT, interhelical loop regions were divided into cytoplasmic or periplasmic. The predicted cytoplasmic contacts between cytoplasmic loops and cytoplasmic ends (within 20%) of TM helices were ignored for the open to cytoplasm conformation. Similarly, the predicted periplasmic contacts between periplasmic loops and periplasmic ends (within 20%) of TM helices were ignored for the closed to cytoplasm conformation. By excluding the one or the other of these sets and keeping all the remaining EC-predicted contacts, two new constraint sets were created which were used to separately refold GlpT from an extended polypeptide. Regions excluded from each conformation prediction are marked with red and green stars on FIG. 8A. Since the 12-helical transporter GlpT and other MFS members consist of two related 6-helical bundles and MFS proteins must perform transport across the membrane by opening and closing access to cytoplasm, the crucial regions which would be reorganized were determined to be the interdomain contacts, rather than the intradomain contacts (FIG. 8A). The distribution of predicted ECs were supported by biological knowledge, as the interdomain ECs showed a greater variability with respect to the cytoplasmic and periplasmic ends than did the intradomain contacts (FIG. 8A).

Comparing the predicted model of Glpt to the crystal structure 1pw4 (cytoplasm-open conformation), the predicted cytoplasmic side of the transporter channel was not as open as in the crystal structure (FIG. 5A). The Glpt evolutionary couplings differed from contacts made in the GlpT crystal structure in an apparently false positive set that would, however, be in contact in a suspected alternative cytoplasm-closed conformation (FIG. 8A). Similarly, a set of contacts could be identified that were consistent only with the cytoplasm-open conformation. To test whether the two alternative sets of evolutionary couplings for GlpT protein would be sufficient to predict the two different conformations, GlpT was refolded with both sets separately (FIG. 8A). As expected, when evolutionary coupling pairs between the domains on the periplasmic side were excluded, models were obtained in a closed-to-cytoplasm conformation, similar in overall structure to the known closed conformation structure of the L-fucose-proton symporter FucP (PDB: 3o7q (Dang et al. (2010) Nature 467, 734-738)) and to a homology model of LacY (Radestock et al. (2011) J. Mol. Biol. 407, 698-715) but distinct from the known open GlpT structure of GlpT (PDB: 1pw4; Huang et al. (2003) Science 301, 616-620). The arrangements of transmembrane helices 5 and 8 and transmembrane helices 2 and 11 in the two folded models differed as expected for “rocking” changes between alternative transporter conformations (Lemieux et al. (2004) Curr. Opin. Struct. Biol. 14, 405-412). Therefore, the evolutionary constraints in the sequence family of GlpT, when decomposed into two overlapping sets, reflected two alternative conformations of the channel.

As human OCTN1 (unknown structure) is also from the major facilitator superfamily, evolutionary couplings in OCTN1 were analyzed to determine whether they contained information about alternative conformations. The top-ranked model of OCTN1 obtained using the methods described herein was compared to all structures in the PDB and significant hits were found to known structures in the major facilitator superfamily, including those of GlpT and FucP. The predicted OCTN1 models, as above for GlpT, looked like an intermediate conformation between outward-open and inward-open, consistent with the expectation that both states are constrained by evolution (FIG. 3). Examination of the distribution of EC pairs suggested that they contained information for two conformations of the transporter (FIG. 8C).

### Evolutionary Constraints Mark Functional Residues

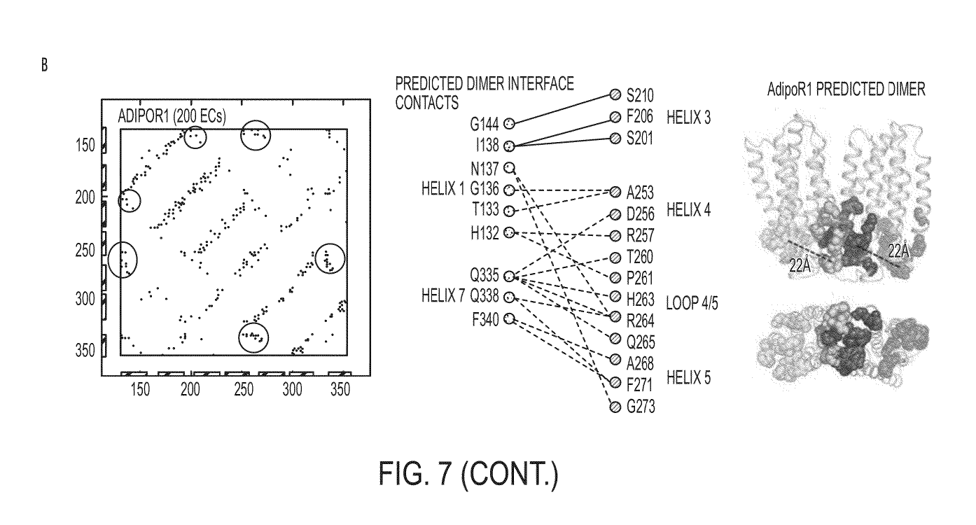

Conservation of amino acids in proteins in single columns is routinely used to infer functional importance of the site and assess the consequences of genetic variation. As the evolutionary analysis described herein reflected both residue-residue correlations and single residue terms, whether the strength of evolutionary couplings on a residue was an indication of its general functional importance for the protein was assessed. The total evolutionary coupling score for a given residue was calculated by summing the evolutionary coupling values over all high-ranking pairs involving that residue as described herein. In Adrb2, Opsd, and GlpT (FIG. 9A), residues with high total coupling scores were found to line the substrate-binding sites and affect signaling or transport; for instance, W109, D113, and Y141 in Adrb2; K296, W265, and H211 in Opsd; and Y393, H165, and K90 in GlpT (Huang et al. (2003) Science 301, 616-620; Law et al. (2008) J. Mol. Biol. 378, 828-839; Valiquette et al. (1995) EMBO J. 14, 5542-5549). Higher prediction accuracy of atomic coordinates near the active sites for Adbr2 and Opsd than for the average of the protein reflected the multiple constraints, i.e., high total coupling score, on these sites (FIG. 9C).

In the unknown structure AdipoR1, residues with a high total coupling score included putative enzymatic residues 5187, H191, D208, H337, and H341 (Holland et al. (2011) Nat. Med. 17, 55-63; Pei et al. (2011) Biol. Direct 6, 37) together with the top three high-scoring residues, C195, A235, and Q335, which clustered together (within about 4 Å) in the predicted 3D structure, indicating that they are important in the activity of AdipoR1 (FIG. 9B). Similarly, clusters of residues with high scoring in OCTN1 made potential salt bridges at the cytoplasmic side of the domains (169R-220E, 397R-450E), clustered in the central transport pore (N210, Y211, C236, E381, and R469), and were potentially involved in conformational changes. Residues with high total coupling scores in the predicted models of human MT-ND1 were clustered in a periplasmic-oriented pocket and along the mitochondrial interface with the hydrophilic domain and the putative quinine-binding site (FIG. 9B) (Efremov et al. (2011) Nature 476, 414-420). Mutations in MT-ND1 at residues Y30 and M31 are associated with Alzheimer's disease and Leber's hereditary optic neuropathy (LHON) (Johns et al. (1992) Biochem. Biophys. Res. Commun. 187, 1551-1557), and these two residues had particularly high total coupling scores, suggesting that they are functionally constrained by interactions with several other residues.

### Discussion

The process of evolution and the sequencing of diverse species have provided the opportunity to compute an important aspect of molecular phenotype, protein 3D structure, and the EVfold method described herein achieves a useful level of accuracy. Additional methods can include: (1) improved information handling in sequence space, such as improvements in weighting schemes for sequences, evaluation of alignment diversity, inclusion of higher-order terms, and consistency filters to reduce the number of false positive pairs; (2) automated procedures to distinguish between internal and homo-oligomer pair contacts and to identify contacts reflecting alternative conformations; (3) the use of fragments imported from known structures; and (4) the use of advanced energy refinement methods, including molecular dynamics and Monte Carlo simulations (Dror et al., 2011; MacCallum et al., 2011).

The methods described herein have many benefits. One is the development of hybrid methods of structure determinations. In NMR spectroscopy, inclusion of evolutionary constraints from sequences may permit structure determination with a smaller number of chemical shifts and NOEs, saving machine time or permitting the solution of larger protein structures than previously reachable. In protein crystallography, the solution of a 3D structure from a native data set alone may become possible, without the need for heavy atom derivatives or MAD phasing, via molecular replacement searches starting with predicted 3D structures. Such methods can significantly increase the productivity of structural biology and the rate of solving new structures.

Beyond structure determination, the predicted models are useful for pharmacological selection of compounds via docking calculations. The observation of exceptionally strong evolutionary constraints near active sites, as reported here for a few proteins, is a favorable starting point, as the accuracy of protein coordinates in active sites and binding sites is an important requirement for computational drug screening. In molecular biology in general, the placement of constrained pairs in the context of known or predicted 3D structures can also provide useful information to guide functional mutational experiments. Similarly, evolutionarily coupled pairs can be excellent design elements for engineering new proteins in synthetic biology and may have a strategic role in the protein folding process.

Inferred evolutionary constraints can also help guide the computational assembly of protein monomers into complexes, with or without low-resolution information from electron diffraction or similar methods. The computational extension to predict the structure of protein complexes can be achieved using pairwise sequence alignments, with a homologous pair of sequences in place of a single sequence and derivation of evolutionary couplings not within a protein but between two potentially interacting proteins. Complexes accessible to such computation are not limited in size, provided sufficiently diverse sequence information is available, as the configuration of even large complexes with tens of constituents effectively can be deduced from calculation of all pairwise protein interactions in the complex.

The methods described herein and the efficiency of the computational implementation, with computation in a couple of hours for proteins up to 500 residues, will allow broad availability of such methods, such as in precomputed or server mode.

The computational methods described herein may be used alone or in combination with other techniques to predict overall fold of 3D structures for biologically interesting members of protein families of unknown structure, with applications in diverse areas of molecular biology. For example, the methods described herein provide more efficient experimental solution of protein structures by x-ray crystallography and NMR spectroscopy, e.g., by eliminating the need for heavy atom derivatives, by guiding the interpretation of electron density maps, and/or by reducing the required number of experimental distance restraints. The methods also allow a survey of arrangements of trans-membrane segments in membrane proteins; identification of remote evolutionary homologies by comparison of 3D structures beyond the power of sequence profiles; prediction of the assembly of domain structures and protein complexes; identification of plausible structures for alternative splice forms of proteins; functional alternative conformers in cases where the computation generates several distinct sets of solutions consistent with the entire set of derived constraints; generation of protein folding pathways where the DI predictions involve residue pairs strategically used along a set of folding trajectories; and prioritization of protein targets and identification of domains of interest for x-ray crystallography and NMR pipelines, e.g., for larger proteins.

Demonstrated herein is the ability of the methods to predict 3D protein structures from sequence information and to identify functional interpretation of evolutionary constraints on residue pair interactions in known and previously unknown sequences. The method can also be used to predict the three-dimensional structures of multidomain proteins and protein complexes.

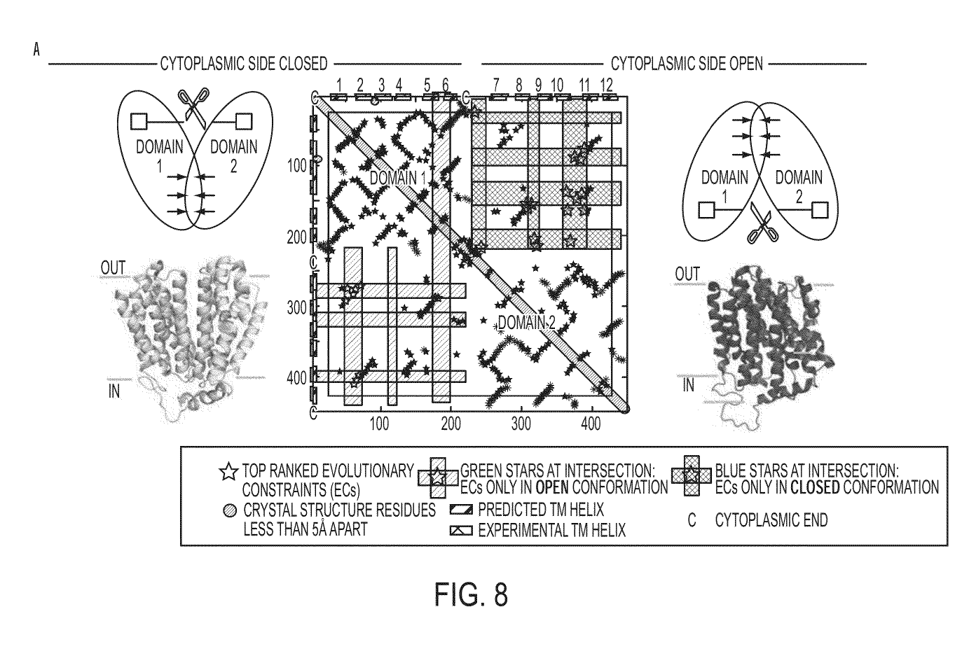

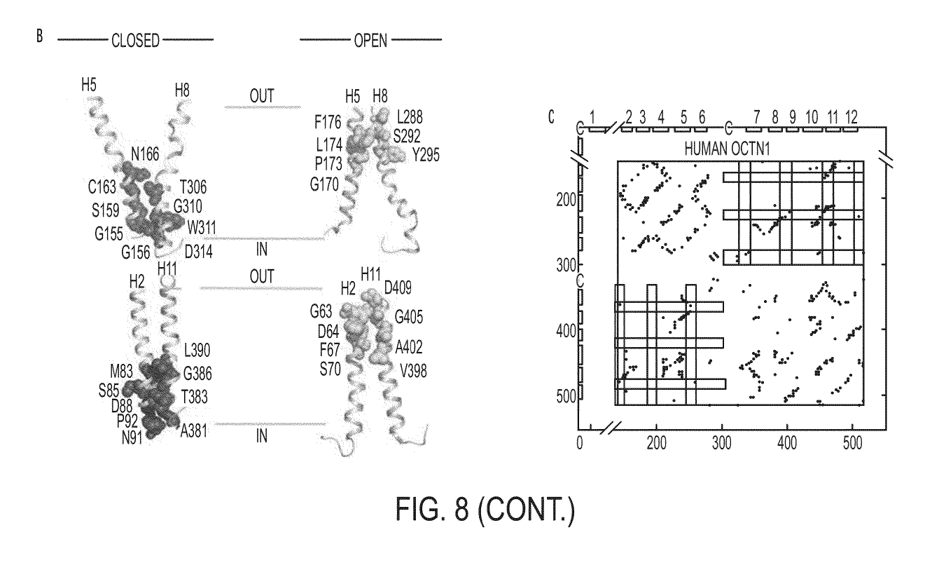

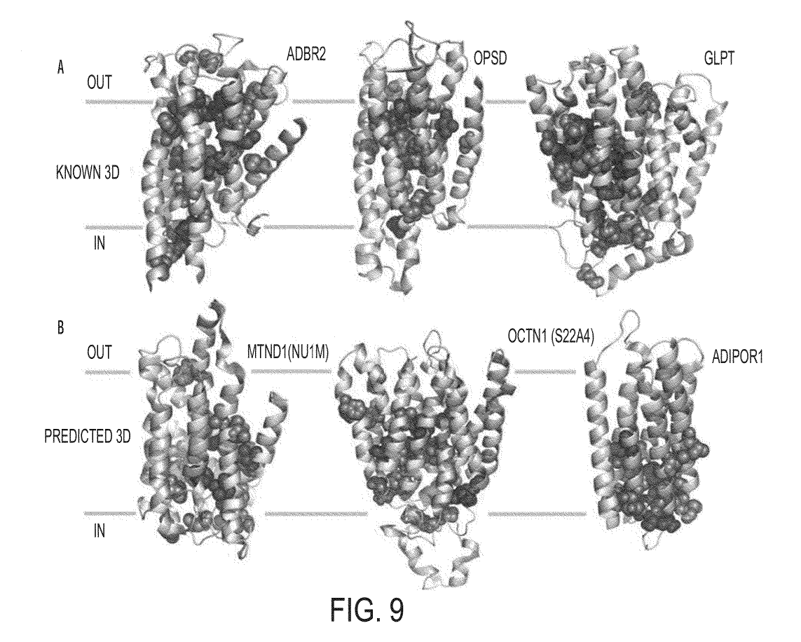

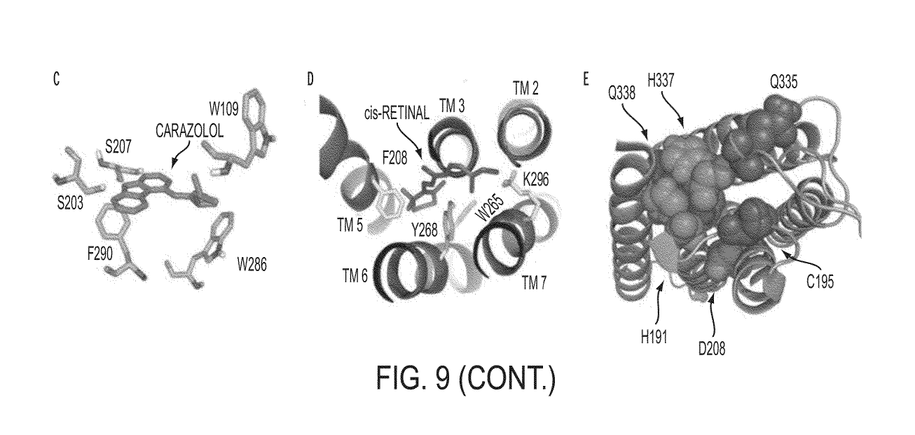

FIG. 10A is a schematic showing that evolutionary couplings identified via the methods described herein can be used to predict 3D protein monomer structure (“within self”), as well as functional interactions between a target protein and other proteins (“with others”) or ligands (“with ligands”), as well as the transmission of information and conformational plasticity. Regarding prediction of interactions between a protein and other proteins, evolutionary constraints reflect the coevolution of residues in homomultimer interaction interfaces, allowing the prediction of both tertiary and quaternary (oligomeric) structures from correlated mutations. Regarding prediction of interactions between a protein and ligands, residues involved in ligand binding of transmembrane receptors are affected by multiple high-ranking evolutionary constraints, which reflect the requirements of a particular spatial arrangement of binding residues, even in the presence of diverse ligand specificities in subfamilies. In proteins with conformational plasticity, evolutionary constraints reflect the proximity of residues in alternative conformations and can be used to fold structural models of the different states. For example, transmembrane helices H5 and H8, and H2 and H11 form two pairs that rock between the alternative conformations of the glycerol-3-phosphate transporter GlpT. The closed conformation (closed to cytoplasm) can be predicted by the EVfold methods described herein, while the open conformation is known from x-ray crystallography data.

The methods described herein are consistent with evolutionary conservation of interactions between residues that are important to maintaining structure and function by constraining the sets of mutations accepted at interacting sites. To find the constraint couplings for each protein, an embodiment method builds a multiple sequence alignment with sufficiently diverse sequences to detect evolutionary co-variation and minimize statistical noise. To maximize the power of detection, the method provides an way to optimize the trade-off between the number of sequences aligned (e.g., depth) and alignment specificity, a proxy for functional similarity to the query sequence, which is quantified by the sequence range (e.g., breadth) covered by the alignment (see FIG. 10B). To identify residue interactions that are conserved by evolution, the method features an entropy maximization technique that extracts patterns of amino acid co-evolution from multiple sequence alignments (see FIG. 10D). The technique reduces the set of all correlations between pairs of positions in the sequence to an essential set which best explains all the other correlations and are therefore likely to be causative, e.g., likely to reflect residue interactions constrained in evolution. This is a “global” statistical approach as opposed to “local” approaches, such as mutual information (MI) and its variants. The MI of pairs of columns in a sequence alignment is “local” in that it quantifies co-variation for each pair independently of all other pairs, potentially leading to inconsistencies. Thus, pairs with high MI scores are not necessarily constrained by a direct interaction effect, even if they are correlated (see FIG. 10C). In contrast, the entropy maximization technique described herein builds a probability model for the entire sequence, such that the scores for each pair of residues are consistent with other pairs, thereby preventing high scoring from transitive relationships in the data.

With a set of distance constraints deduced from evolutionary couplings, the method employs biomolecular computing to generate all-atom three-dimensional structures. The method can further include: (1) translation of EC's to distance constraints with a small number of empirical selection rules that take into account chain proximity and secondary structure segments; (2) a distance geometry algorithm to convert a set of distances among L points to an 3-dimensional embedding; and (3) regularization of molecular geometry using empirical force fields, complemented by a set of harmonic distance constraints (from the EC's) using a molecular dynamics protocol called simulated annealing. The CNS suite, with its powerful set of protein structure algorithms, can be used, for example. For example, one may start from an extended polypeptide chain of one protein of interest in the protein family, add distance constraints derived from the sequence neighborhood of protein or of the entire family, and generate (one or many sets of) all atom coordinates. The information in the final 3D structures is partly generic to the entire family and partly specific to the particular protein. To explore the information content in the evolutionary couplings (ECs), the method may include identifying the top K constraints, starting at about 40 and going up to L constraints, where L is the length of the protein. The robustness of the calculations is apparent from two effects: (1) the relatively small number of constraints needed (L out of a possible L2 number of residue pairs) and the stability of the results with respect to different K cutoff on the list of constraints.

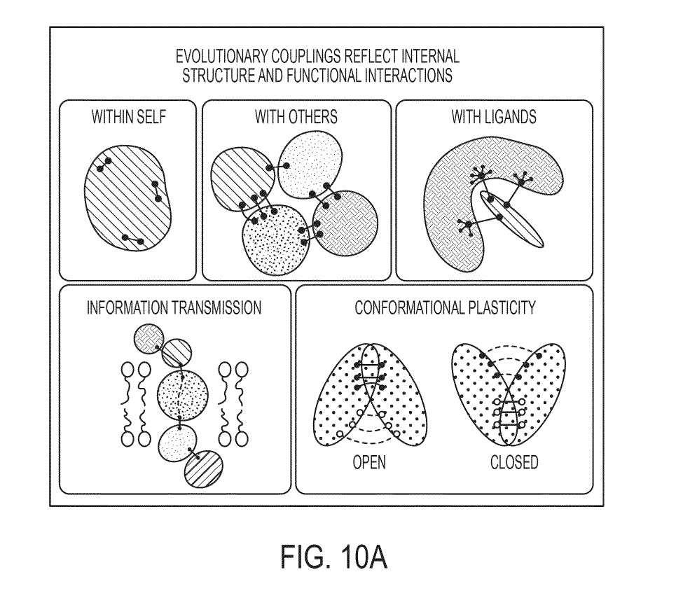

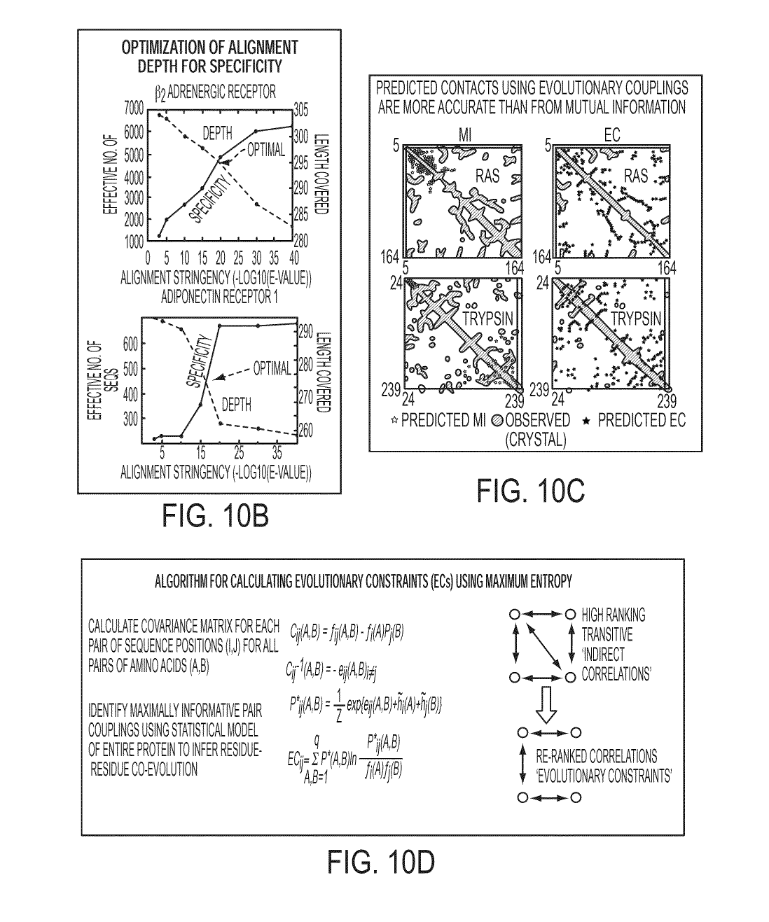

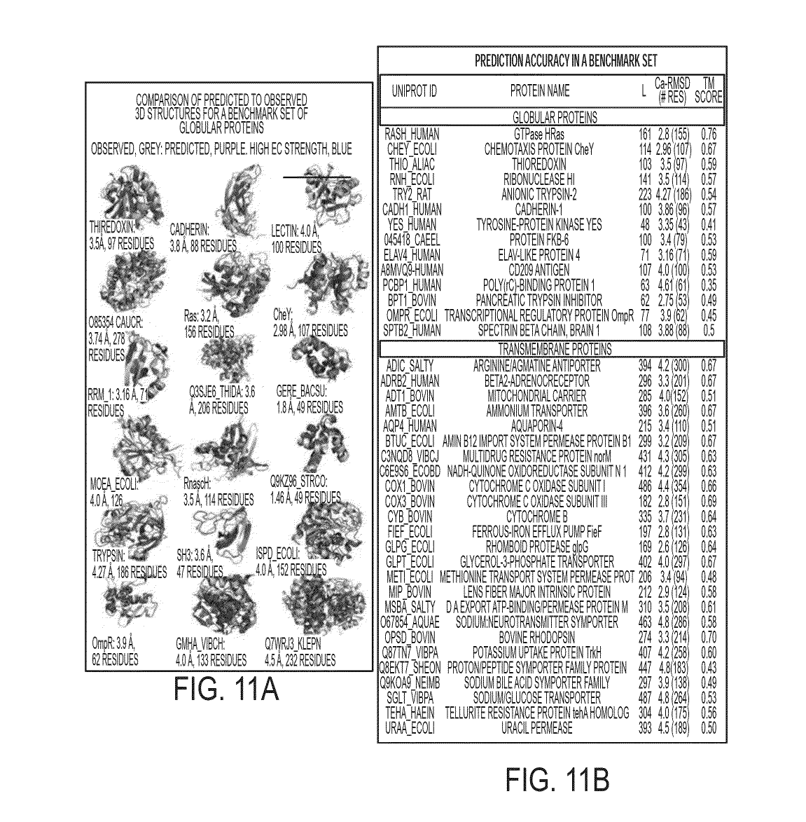

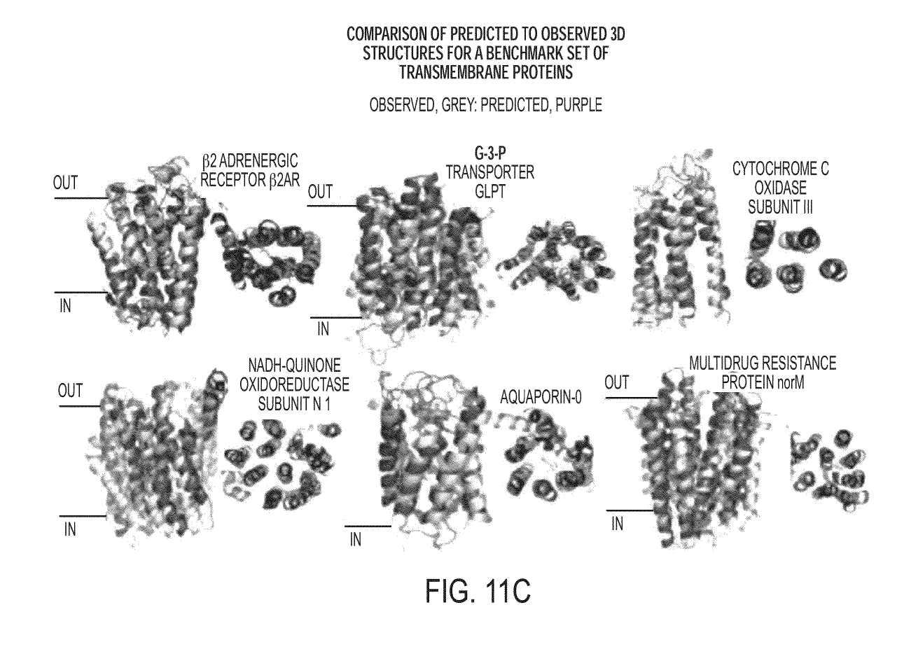

Experiments were performed to test the ability of the method to predict 3D structure of proteins from sequence alone on a set of 15 diverse globular folds of up to 220 amino acids in length. The predicted structures have good (and unprecedented) topological agreement with experimentally determined structures, with structural elements well-placed in 3D space and with an overall accuracy of as low as 2.8-5.1 Å Cα-rmsd relative to the experimentally determined structures, and with excellent TM scores in the 0.35-0.76 range (FIG. 11A, 11B). In a few proteins there are occasional errors of positioning of secondary structure elements; predictions are surprisingly robust with respect to false positive predicted contacts; about 300-1000 sequences are needed to obtain a good fold; enzymes tend to work best; in several cases analyzed in detail, accuracy of atomic coordinates are excellent (down to ˜1 Å) around active sites. It is seen that the method often provides the correct fold, even for larger proteins, that more sequence information tends to lead to higher accuracy, and that advanced refinement may provide even more accurate coordinates.

Experiments were also performed to test the ability of the method to predict the 3D structures of membrane proteins on a set of 25 membrane proteins with up to 487 residues (up to 14 transmembrane helices) in 23 structurally diverse families. These were α-helical membrane proteins from PFAM families with more than 1000 sequences, sufficient coverage of alignment along the length of the sequence and more than 5 helices. This protein set included examples from important functional classes, such as GPCRs and membrane transporters (FIG. 11B). As with the globular protein set, no information from homologous 3D structures was used, nor were sequence-similar fragments used. The EVfold-membrane protocol provides a ranked set of predicted structures for each protein, which were compared to a cognate crystal structure. Accuracy results range from Cα-rmsd of 2.6-4.8 Å over >70% of the length and template modeling TM scores of 0.5-0.7, again exceptionally good for de novo predictions of proteins of this size (FIGS. 11C and 11D).

Currently, state-of-the-art approaches for de novo folding are based primarily on searching for sequence-similar fragments in 3D structure databases followed by fragment assembly using specially designed empirical force fields. These approaches, such as Rosetta, are mostly limited to molecules less than ˜120 amino acids and most considerably smaller, are limited by the prohibitively increasing size of the conformational search space as the size of the protein increases. Accordingly, their ability of de novo 3D structure prediction is limited. Various advantages of EVfold over Rosetta and similar methods are apparent in terms of (i) protein size range, (ii) prediction accuracy, and (iii) efficiency of conformational search. To illustrate these differences, experiments were performed to predict structures for five of the proteins predicted by Barth et al. (2009) (2). EVfold reached the threshold coordinate accuracy of 4 Å over comparable or significant larger regions (e.g., 89% rather than 40% of residues for bovine rhodopsin), and it explored conformational search space more efficiently (e.g., ˜500 candidate models compared to 200,000). As an additional advantage, EVfold all-atom models can be generated on a laptop in a few minutes per structure, without the need for supercomputers. While the method has considerable advantage in terms of de novo prediction and efficiency of conformational search, it is possible to further include advance energy functions and fragment search for further improvements.

Methods described herein allow 3D structure prediction of medically interesting transmembrane proteins, for example. The transmembrane proteins evaluated by the method described herein have reported disease associations including diabetes, obesity, Crohns disease, breast cancer, a hereditary optic neuropathy, Alzheimer's disease, and Parkinson's disease. Several hundred all-atom 3D models were determined for each protein, then ranked according to an empirical score. The identified coordinates allow interpretation and design of targeted experiments. Predicted 3D structures can be used in a number of ways, including identification of putative binding and interaction sites and computational drug screening, which is possible due to the higher accuracy seen near active sites in the benchmarks.

As prediction accuracy using EVfold constraints is generally higher near active sites and binding sites (examples in globular proteins: active or binding sites in Ras, Trypsin, Thioredoxin, CheY, OmprR; examples in transmembrane proteins: retinal binding site in rhodopsin, carazolol binding in the GPCR Adrb2), strong EC pair constraints are an apparent signature of functional constraints. This can be generalized and applied to the prediction of functional elements in a number of ways. For example, cumulative EC strength may be determined and used for a particular residue as a measure of the effect of functional selective pressure on one residue (that as a single residue does not have to be strongly conserved). Furthermore, chains of residue pairs with high EC values may be identified as potential chains of transmission of information, e.g., in receptors. The use of EC's to identify functional sites and functional chains is described herein. From this, it can be seen that the method may be used to undertake a comprehensive analysis across a set of known sites (benchmark) and predict them. Such predictions are useful to prepare mutations experiments, and to mechanistically interpret the function effects of so-called hypomorphs, of amino-acid-changing SNPs, and of somatic functional mutations in cancer.

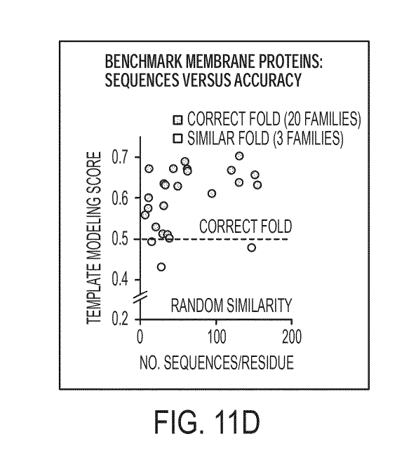

Constraints of biological function have an effect on sequence via interactions, not all of which are internal to a protein. Another very interesting class of functional interactions are sites of oligomer formation. Described herein is the identification of which of the predicted contacts between residues in one sequence fall between two symmetrical monomers in a homooligomer (FIG. 12). Such interactions appear as false positives when comparing predicted contacts with intramonomer contacts in known structures. In de novo predicted cases, a technique is needed that disambiguates between intra-monomer and intermonomer contacts in an oligomer. This problem is analogous to a problem in NMR structure determination of oliogmers. Using methods described herein, it is possible to predict, e.g., the dimer interface of the de novo predicted adiponectin receptor structure (FIG. 12). In addition to generating predicted oligomer structure, such a technique can contribute to monomer folding accuracy, where the conflicting oligomer contacts are removed in the process of computing the oligomer structure. The approach is closely related to the prediction of the structure of protein complexes. The maximum entropy EC approach can be used, for example, for the prediction of the interactions of the histidine kinase-response regulator interactions. The generalization of prediction of pairwise protein-protein interactions to that of entire protein complexes is computationally straightforward, in analogy to the computation of the higher order structure of the nuclear pore complex from pair interactions deduced for mass spectrometry data after selective purification of partial components of the complexes. The information content in aggregated multiple sequence alignments can be used to solve this problem per methods described herein. Elucidating the structure of large protein assemblies from known-structure or predicted-structure components is a particularly valuable application of the methods described herein.

Many proteins can adopt different distinct conformations as part of their function. Methods described herein can be used to predict alternative conformations from one set of ECs. For example, an analysis of known and de novo predicted structures (GlpT, Octn1) in the large Major Facilitator Superfamily was conducted using methods described herein. Models of the two conformations were identified by selection of alternative groups of interdomain contacts. From this and other examples, it is apparent that for some proteins with functional conformational flexibility, the record of functional constraints in multiple sequence alignments is sufficiently strong to permit modeling not just of one structure, but of alternative structures representing the end points of functional conformational transition.

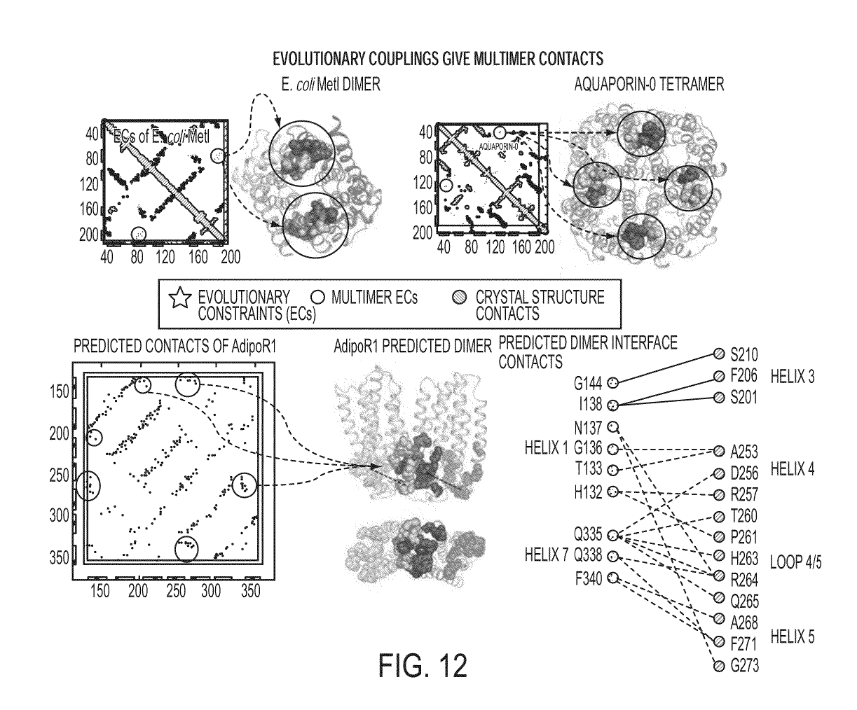

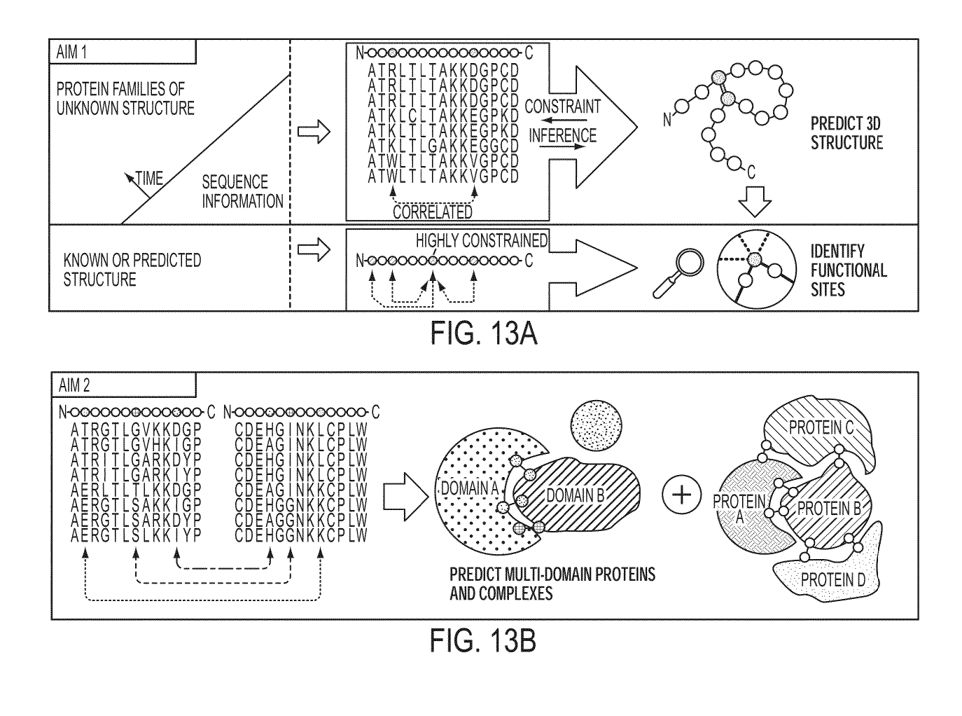

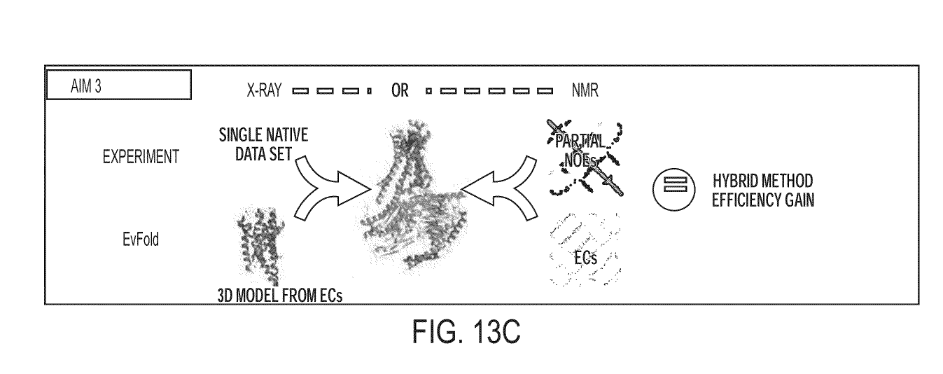

FIGS. 13A, 13B, and 13C are schematic diagrams that demonstrate certain applications of the techniques described herein. For example, FIG. 13A demonstrates the prediction of unknown 3D structures of protein domains, as well as the identification of functional sites on both known and unknown structures, according to illustrative embodiments described herein. Aggregate pair constraints on individual residues correlate with functional involvement such as for residues in ligand binding, active sites, oligomerization and conformational change. Furthermore, chains of pair constraints may indicate channels of information transmission (e.g., GPCRs).

FIG. 13B demonstrates the prediction of multi-domain proteins and complexes, according to illustrative embodiments described herein. Extracting evolutionary constraints predictive of interactions between protein domains is an extension of that for intra-domain contacts. First, a multiple sequence alignment is aggregated with the sequences of the interacting partners in one line. For protein-protein interaction, this involves knowledge of homologous pairs in different species, obtained using standard methods for detection of homologs. Given two domains, evolutionary inter-domain couplings are extracted using maximum entropy, followed by three-dimensional assembly using, for example, the CNS or Haddock software. Thus, in one embodiment, the steps are (1) construction of multiple sequence alignments, (2) evaluation of evolutionary depth, sequence diversity and/or subfamily structure, (3) derivation of EC's with calibration of cutoff, (4) derivation of weighted distance constraints for Haddock/CNS, (5) computation of all-atom coordinates of complexes, and (6) using generalizations of known measures to evaluate prediction accuracy both in terms of contacts and of 3D structure assembly.

For application to domain-domain interactions, one example is the identification of multidomain structures and protein-protein interaction for human receptors. Taking the example of the EGFR/HER family, while detailed structures of parts of these are known, there is crucial missing structural information for parts between the transmembrane section and the catalytic cytoplasmic domain, conformational change involving these, as well as open questions regarding hetero-oligomerization within the family, both in the extracellular and cytoplasmic domains. Methods described herein can be applied to the prediction of such complicated biomolecular assemblies.

Conformational changes in multidomain proteins may also be deduced using embodiments described herein. Interesting test cases of proteins as molecular switches of known structure include the serpins, as well as G-domains.

FIG. 13C demonstrates efficient hybrid computational-experimental methods for structure determination, especially useful for larger structures and complexes. For example, evolutionary co-variation deduced from sequences according to the techniques described herein can be useful for this. While this information is sufficient to compute the correct fold, for many proteins, it is desirable to achieve higher accuracy of atomic coordinates by using experimental information, e.g., via X-ray crystallography and/or via NMR spectroscopy, so as to achieve rapid determination of high-accuracy structures. For example, EC distance constraints determined as discussed herein can be combined with NMR backbone chemical shifts and sparse NMR-derived distance constraints. Information deduced from evolutionary pair constraints determined according to embodiments described herein can provide a savings in the NMR experimental effort required, as well as increase the size limit for NMR structure determination that can be achieved.

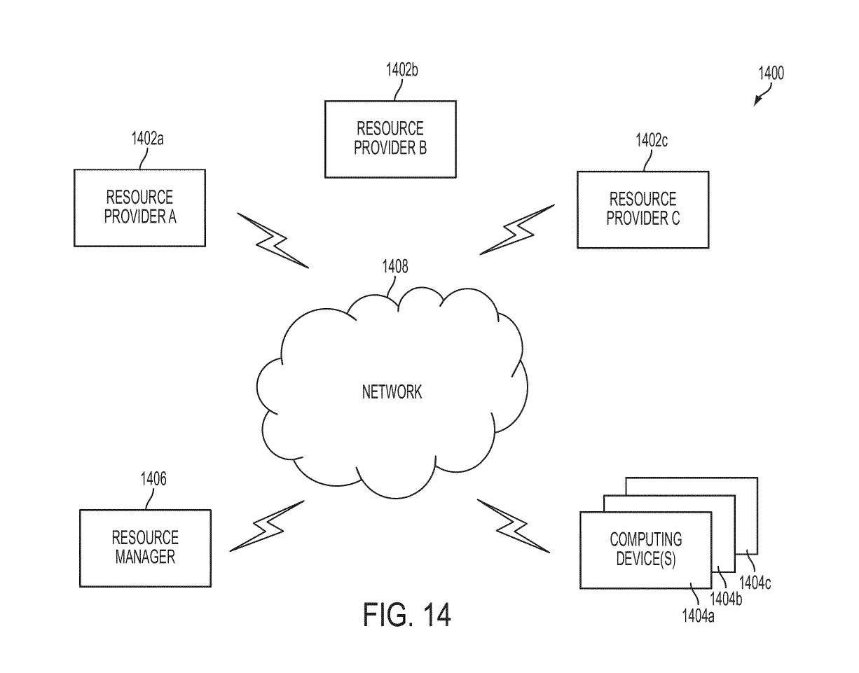

As shown in FIG. 14, an implementation of a network environment 1400 for predicting protein structures is shown and described. In brief overview, referring now to FIG. 14, a block diagram of an exemplary cloud computing environment 1400 is shown and described. The cloud computing environment 1400 may include one or more resource providers 1402a, 1402b, 1402c (collectively, 1402). Each resource provider 1402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1402 may be connected to any other resource provider 1402 in the cloud computing environment 1400. In some implementations, the resource providers 1402 may be connected over a computer network 1408. Each resource provider 1402 may be connected to one or more computing device 1404a, 1404b, 1404c (collectively, 1404), over the computer network 1408.

The cloud computing environment 1400 may include a resource manager 1406. The resource manager 1406 may be connected to the resource providers 1402 and the computing devices 1404 over the computer network 1408. In some implementations, the resource manager 1406 may facilitate the provision of computing resources by one or more resource providers 1402 to one or more computing devices 1404. The resource manager 1406 may receive a request for a computing resource from a particular computing device 1404. The resource manager 1406 may identify one or more resource providers 1402 capable of providing the computing resource requested by the computing device 1404. The resource manager 1406 may select a resource provider 1402 to provide the computing resource. The resource manager 1406 may facilitate a connection between the resource provider 1402 and a particular computing device 1404. In some implementations, the resource manager 1406 may establish a connection between a particular resource provider 1402 and a particular computing device 1404. In some implementations, the resource manager 1406 may redirect a particular computing device 1404 to a particular resource provider 1402 with the requested computing resource.

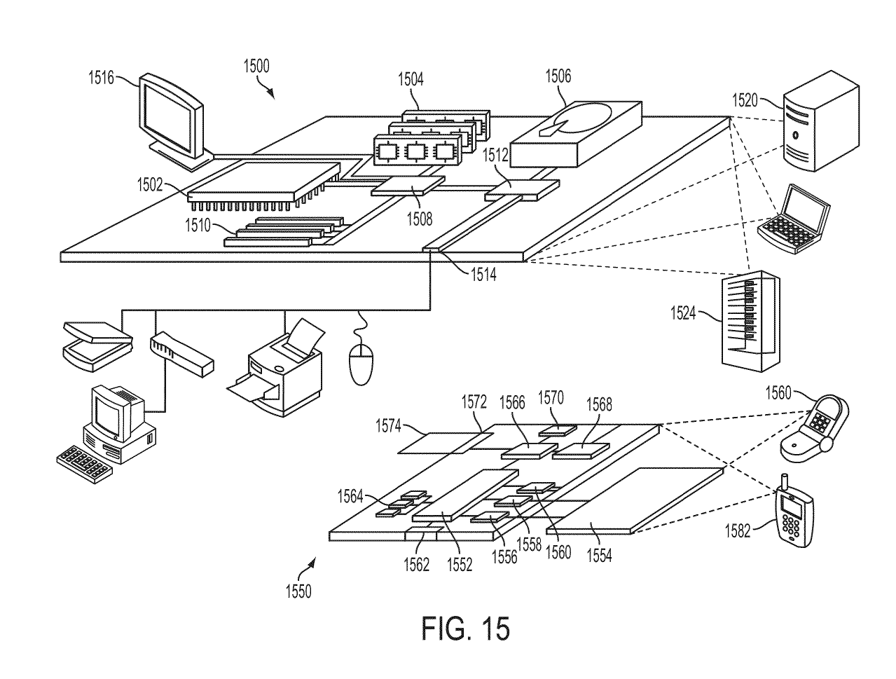

FIG. 15 shows an example of a computing device 1500 and a mobile computing device 1550 that can be used to implement the techniques described in this disclosure. The computing device 1500 is intended to represent various forms of digital computers, such as laptops, desktops, workstations, personal digital assistants, servers, blade servers, mainframes, and other appropriate computers. The mobile computing device 1550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1500 includes a processor 1502, a memory 1504, a storage device 1506, a high-speed interface 1508 connecting to the memory 1504 and multiple high-speed expansion ports 1510, and a low-speed interface 1512 connecting to a low-speed expansion port 1514 and the storage device 1506. Each of the processor 1502, the memory 1504, the storage device 1506, the high-speed interface 1508, the high-speed expansion ports 1510, and the low-speed interface 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as a display 1516 coupled to the high-speed interface 1508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1504 stores information within the computing device 1500. In some implementations, the memory 1504 is a volatile memory unit or units. In some implementations, the memory 1504 is a non-volatile memory unit or units. The memory 1504 may also be another form of computer-readable medium, such as a magnetic or optical disk.

The storage device 1506 is capable of providing mass storage for the computing device 1500. In some implementations, the storage device 1506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1502), perform one or more methods, such as those described above. The instructions can also be stored by one or more storage devices such as computer- or machine-readable mediums (for example, the memory 1504, the storage device 1506, or memory on the processor 1502).

The high-speed interface 1508 manages bandwidth-intensive operations for the computing device 1500, while the low-speed interface 1512 manages lower bandwidth-intensive operations. Such allocation of functions is an example only. In some implementations, the high-speed interface 1508 is coupled to the memory 1504, the display 1516 (e.g., through a graphics processor or accelerator), and to the high-speed expansion ports 1510, which may accept various expansion cards (not shown). In the implementation, the low-speed interface 1512 is coupled to the storage device 1506 and the low-speed expansion port 1514. The low-speed expansion port 1514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. In addition, it may be implemented in a personal computer such as a laptop computer 1522. It may also be implemented as part of a rack server system 1524. Alternatively, components from the computing device 1500 may be combined with other components in a mobile device (not shown), such as a mobile computing device 1550. Each of such devices may contain one or more of the computing device 1500 and the mobile computing device 1550, and an entire system may be made up of multiple computing devices communicating with each other.

The mobile computing device 1550 includes a processor 1552, a memory 1564, an input/output device such as a display 1554, a communication interface 1566, and a transceiver 1568, among other components. The mobile computing device 1550 may also be provided with a storage device, such as a micro-drive or other device, to provide additional storage. Each of the processor 1552, the memory 1564, the display 1554, the communication interface 1566, and the transceiver 1568, are interconnected using various buses, and several of the components may be mounted on a common motherboard or in other manners as appropriate.

The processor 1552 can execute instructions within the mobile computing device 1550, including instructions stored in the memory 1564. The processor 1552 may be implemented as a chipset of chips that include separate and multiple analog and digital processors. The processor 1552 may provide, for example, for coordination of the other components of the mobile computing device 1550, such as control of user interfaces, applications run by the mobile computing device 1550, and wireless communication by the mobile computing device 1550.

The processor 1552 may communicate with a user through a control interface 1558 and a display interface 1556 coupled to the display 1554. The display 1554 may be, for example, a TFT (Thin-Film-Transistor Liquid Crystal Display) display or an OLED (Organic Light Emitting Diode) display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may provide communication with the processor 1552, so as to enable near area communication of the mobile computing device 1550 with other devices. The external interface 1562 may provide, for example, for wired communication in some implementations, or for wireless communication in other implementations, and multiple interfaces may also be used.

The memory 1564 stores information within the mobile computing device 1550. The memory 1564 can be implemented as one or more of a computer-readable medium or media, a volatile memory unit or units, or a non-volatile memory unit or units. An expansion memory 1574 may also be provided and connected to the mobile computing device 1550 through an expansion interface 1572, which may include, for example, a SIMM (Single In Line Memory Module) card interface. The expansion memory 1574 may provide extra storage space for the mobile computing device 1550, or may also store applications or other information for the mobile computing device 1550. Specifically, the expansion memory 1574 may include instructions to carry out or supplement the processes described above, and may include secure information also. Thus, for example, the expansion memory 1574 may be provide as a security module for the mobile computing device 1550, and may be programmed with instructions that permit secure use of the mobile computing device 1550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1552), perform one or more methods, such as those described above. The instructions can also be stored by one or more storage devices, such as one or more computer- or machine-readable mediums (for example, the memory 1564, the expansion memory 1574, or memory on the processor 1552). In some implementations, the instructions can be received in a propagated signal, for example, over the transceiver 1568 or the external interface 1562.

The mobile computing device 1550 may communicate wirelessly through the communication interface 1566, which may include digital signal processing circuitry where necessary. The communication interface 1566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1568 using a radio-frequency. In addition, short-range communication may occur, such as using a Bluetooth®, Wi-Fi™, or other such transceiver (not shown). In addition, a GPS (Global Positioning System) receiver module 1570 may provide additional navigation- and location-related wireless data to the mobile computing device 1550, which may be used as appropriate by applications running on the mobile computing device 1550.

The mobile computing device 1550 may also communicate audibly using an audio codec 1560, which may receive spoken information from a user and convert it to usable digital information. The audio codec 1560 may likewise generate audible sound for a user, such as through a speaker, e.g., in a handset of the mobile computing device 1550. Such sound may include sound from voice telephone calls, may include recorded sound (e.g., voice messages, music files, etc.) and may also include sound generated by applications operating on the mobile computing device 1550.

The mobile computing device 1550 may be implemented in a number of different forms, as shown in the figure. For example, it may be implemented as a cellular telephone 1580. It may also be implemented as part of a smart-phone 1582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for predicting protein structures are provided. Having described certain implementations of methods and apparatus for supporting protein structure predictions, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

The mention herein of any references, e.g., in the Background section, is not an admission that such material is prior art.

It should be understood that the order of steps or order for performing certain action is immaterial so long as the invention remains operable. Moreover, two or more steps or actions may be conducted simultaneously.

### OTHER EMBODIMENTS AND EQUIVALENTS

While the present disclosures have been described in conjunction with various embodiments and examples, it is not intended that they be limited to such embodiments or examples. On the contrary, the disclosures encompass various alternatives, modifications, and equivalents, as will be appreciated by those of skill in the art. Accordingly, the descriptions, methods and diagrams of should not be read as limited to the described order of elements unless stated to that effect.

Although this disclosure has described and illustrated certain embodiments, it is to be understood that the disclosure is not restricted to those particular embodiments. Rather, the disclosure includes all embodiments that are functional and/or equivalents of the specific embodiments and features that have been described and illustrated.

We claim:

1. A method of predicting structure of a polypeptide, the method comprising the steps of:
(a) generating a multiple sequence alignment for an amino acid sequence of a polypeptide;
(b) identifying evolutionary constraints for the polypeptide from the multiple sequence alignment using a statistical analysis; and
(c) simulating folding of an extended chain structure of the polypeptide using the identified constraints, thereby predicting one or more structures corresponding to the polypeptide.

2. The method of claim 1, wherein the polypeptide is a transmembrane protein and wherein the method comprises identifying evolutionary constraints corresponding to residue pairs predicted to be close in 3D space, and eliminating evolutionary constraints for which 3D proximity is unlikely due to presence of a membrane.

3. The method of claim 2, wherein the structure is a structure of the entire protein.

4. The method of claim 1, wherein the statistical analysis in step (b) is an entropy maximization analysis.

5. The method of claim 1, comprising the step of identifying multiple 3D conformations of the polypeptide.

6. The method of claim 1, further comprising using the one or more predicted structures to identify one or more active sites, one or more binding sites, or one or more active sites and binding sites via docking calculations, and constructing or determining a candidate drug using the identified active sites or binding sites.

7. The method of claim 6, further comprising the step of synthesizing the candidate drug.

8. The method of claim 1, further comprising synthesizing the polypeptide, wherein the polypeptide has a desired structure as predicted in step (c).

9. The method of claim 1, wherein the polypeptide is a transmembrane protein comprising an α-helical chain.

10. The method of claim 9, wherein the protein is a G protein-coupled receptor (GPCR).

11. The method of claim 9, wherein the protein has greater than 7 transmembrane helices.

12. The method of claim 1, comprising ranking the predicted one or more structures using a quality measure of backbone alpha torsion and/or beta sheet twist.

13. The method of claim 1, wherein step (c) comprises:
(i) identifying residue-residue distance constraints corresponding to the identified evolutionary constraints; and
(ii) generating three-dimensional coordinates corresponding to the identified residue-residue distance constraints using a distance geometry algorithm.

14. The method of claim 13, wherein step (c) further comprises:
(iii) refining the three-dimensional coordinates by performing simulated annealing to determine a plurality of predicted structures; and
(iv) ranking the predicted structures.

15. An apparatus for predicting structure of a polypeptide, the apparatus comprising:
a memory for storing a code defining a set of instructions; and
a processor for executing the set of instructions,
wherein the code comprises an analysis module configured to:
(a) generate a multiple sequence alignment for an amino acid sequence of a polypeptide;
(b) identify evolutionary constraints for the polypeptide from the multiple sequence alignment using a statistical analysis; and
(c) simulate folding of an extended chain structure of the polypeptide using the identified constraints, thereby predicting one or more structures corresponding to the polypeptide.

16. The apparatus of claim 15, wherein the polypeptide is a transmembrane protein and wherein the analysis module is configured to identify evolutionary constraints corresponding to residue pairs predicted to be close in 3D space, and eliminate evolutionary constraints for which 3D proximity is unlikely due to presence of a membrane.

17. The apparatus of claim 16, wherein the structure is a structure of the entire protein.

18. The apparatus of claim 15, wherein the statistical analysis is an entropy maximization analysis.

19. The apparatus of claim 15, wherein the analysis module is configured to identify multiple 3D conformations of the polypeptide.

20. The apparatus of claim 15, wherein the analysis module is further configured to identify one or more active sites, one or more binding sites, or one or more active sites and binding sites via docking calculations using the one or more predicted structures, and construct or determine a candidate drug using the identified active sites or binding sites.

21. The apparatus of claim 15, wherein the polypeptide is a transmembrane protein comprising an α-helical chain.

22. The apparatus of claim 21, wherein the protein is a G protein-coupled receptor (GPCR).

23. The apparatus of claim 21, wherein the protein has greater than 7 transmembrane helices.

24. The apparatus of claim 15, wherein the analysis module is configured to rank the predicted one or more structures using a quality measure of backbone alpha torsion and/or beta sheet twist.

25. A method of identifying an interaction partner of a target polypeptide, the method comprising:
(a) providing a target polypeptide structure for a target polypeptide predicted by a method comprising:
(i) generating a multiple sequence alignment for an amino acid sequence of the target polypeptide;
(ii) identifying evolutionary constraints for the target polypeptide from the multiple sequence alignment using a statistical analysis; and
(iii) simulating folding of an extended chain structure of the target polypeptide using the identified constraints, thereby predicting a structure corresponding to the target polypeptide;
(b) for each of a plurality of candidate interaction partners, docking in silico the predicted structure of the target polypeptide with a known or predicted structure of the candidate interaction partner, thereby determining a score associated with the candidate interaction partner; and
(c) identifying one or more of the candidate interaction partners whose score satisfies a predetermined criterion as an interaction partner of the target polypeptide.

26. The method of claim 25, wherein the interaction partner is a binding partner.

27. The method of claim 25, wherein the score is a free energy score.

28. The method of claim 25, wherein the candidate interaction partner is or comprises a small molecule.

29. The method of claim 25, wherein the candidate interaction partner is or comprises a polypeptide.

30. A method of selecting an amino acid sequence, comprising:
providing a target three-dimensional polypeptide structure;
providing an initial amino acid sequence;
determining a structure of the initial amino acid sequence by:
(i) generating a multiple sequence alignment for the initial amino acid sequence;
(ii) identifying evolutionary constraints for the initial amino acid sequence from the multiple sequence alignment using a statistical analysis; and
(iii) simulating folding of an extended chain structure of the initial amino acid sequence using the identified constraints, thereby determining a structure corresponding to the initial amino acid sequence; and
selecting the initial amino acid sequence if the target polypeptide structure and structure of the initial amino acid sequence are sufficiently similar.

31. The method of claim 30, further comprising modifying the initial amino acid sequence;
and determining a structure of the modified amino acid sequence by steps (i) to (iii).

32. The method of claim 31, further comprising repeating the modifying step until the target polypeptide structure and the modified amino acid sequence structure are sufficiently similar.

33. A method of designing a modified polypeptide, comprising:
providing a target structure of an amino acid sequence determined by:
(i) generating a multiple sequence alignment for the amino acid sequence;
(ii) identifying evolutionary constraints for the amino acid sequence from the multiple sequence alignment using a statistical analysis; and
(iii) simulating folding of an extended chain structure of the amino acid sequence using the identified constraints, thereby determining a target structure corresponding to the amino acid sequence; and
identifying in the provided target structure at least one site for modification.

34. The method of claim 33, further comprising identifying a portion of the amino acid sequence corresponding to the at least one site identified for modification.

35. The method of claim 34, further comprising modifying the identified portion of the amino acid sequence and determining a structure of the modified amino acid sequence.

36. The method of claim 35, wherein the amino acid sequence is modified by one or more of a substitution, deletion, or insertion of one or more amino acids within the identified portion.

37. The method of claim 35, wherein the at least one site for modification is identified by docking in silico the provided target structure with a known or predicted structure of a candidate interaction partner.

38. The method of claim 37, further comprising docking in silico the modified amino acid structure with the structure of the candidate interaction partner and determining whether the modification affects affinity or specificity of an interaction of the candidate interaction partner and the target structure.

39. A method of designing an amino acid sequence, comprising:
determining a set of structural arrangement characteristics;
providing a plurality of amino acid sequences;
for each of the plurality of amino acid sequences:
(i) generating a multiple sequence alignment for the amino acid sequence;
(ii) identifying evolutionary constraints for the amino acid sequence from the multiple sequence alignment using a statistical analysis; and
(iii) simulating folding of an extended chain structure of the amino acid sequence using the identified constraints, thereby determining a structure corresponding to the amino acid sequence; and
selecting a set of amino acid sequences from the plurality that, taken together, achieve the determined set of structural arrangement characteristics, thereby designing an amino acid sequence.

40. The method of claim 39, further comprising assigning a linear order to the selected set of amino acid sequences such that, when folded in three dimensional space, achieves the determined set of structural arrangement characteristics, thereby producing a linear amino acid sequence.

41. The method of claim 40, wherein the plurality of amino acid sequences is provided in a library.

42. The method of claim 41, wherein the plurality of amino acid sequences is provided in a phage display library.

43. The method of claim 40, further comprising producing a polypeptide encoded by the linear amino acid sequence.

44. A method of determining a structure of a polypeptide, the method comprising:
(a) generating a multiple sequence alignment for an amino acid sequence of a polypeptide;
(b) identifying evolutionary constraints for the polypeptide from the multiple sequence alignment using a statistical analysis;
(c) performing X-ray crystallography and/or NMR experiments on a sample of the polypeptide, thereby identifying one or more experimentally-determined structural constraints for the polypeptide; and
(d) using the identified evolutionary constraints in step (b) and the experimentally-determined structural constraints in step (c) to determine the structure of the polypeptide.

45. The method of claim 44, further comprising using the identified evolutionary constraints identified in step (b) to design the X-ray crystallography and/or NMR experiments performed in step (c) to identify the one or more experimentally-determined structural constraints for the polypeptide.

46. The method of claim 1, further comprising comparing the predicted structure of the polypeptide with a known structure of the polypeptide, wherein identified evolutionary constraints that are inconsistent with the known structure are indicative that the polypeptide forms a dimer with a second polypeptide.

47. The method of claim 46, further comprising providing a structure of the second polypeptide.

48. The method of claim 47, further comprising simulating folding of the polypeptide and the second polypeptide into a dimer using the identified inconsistent evolutionary constraints as distance constraints between the polypeptide and the second polypeptide.

49. A method of predicting structure of a multi-domain polypeptide, the method comprising the steps of:
(a) generating a first multiple sequence alignment for an amino acid sequence of a first domain of a multi-domain polypeptide;
(b) generating a second multiple sequence alignment for an amino acid sequence of a second domain of the polypeptide;
(c) identifying evolutionary constraints (e.g., inter-domain couplings) for the first and second domains from the first multiple sequence alignment and the second multiple sequence alignment using a statistical analysis; and
(d) simulating folding of extended chain structures of the first and second domains using the identified evolutionary constraints, thereby predicting one or more structures corresponding to the multi-domain polypeptide.

50. The method of claim 49, further comprising evaluating evolutionary depth, sequence diversity, and/or subfamily structure within each of the first multiple sequence alignment and the second multiple sequence alignment.

51. The method of claim 49, comprising identifying the evolutionary constraints with calibration of cutoff.

52. The method of claim 49, further comprising identifying weighted distance constraints (e.g., using Haddock/CNS).

53. The method of claim 49, further comprising identifying all-atom coordinates of the multi-domain polypeptide.

54. The method of claim 49, further comprising evaluating prediction accuracy.

55. A method of predicting structure of a polypeptide complex, the method comprising the steps of:
(a) providing an amino acid sequence for each polypeptide of a polypeptide complex;
(b) generating a multiple sequence alignment for each polypeptide, including a first multiple sequence alignment for a first polypeptide and a second multiple sequence alignment for a second polypeptide;
(c) identifying evolutionary constraints (e.g., inter-polypeptide couplings) from the first multiple sequence alignment and the second multiple sequence alignment using a statistical analysis; and
(d) simulating folding of extended chain structures of the polypeptides using the identified evolutionary constraints, thereby predicting one or more structures corresponding to the polypeptide complex.

56. The method of claim 55, further comprising evaluating evolutionary depth, sequence diversity, and/or subfamily structure within each of the first multiple sequence alignment and the second multiple sequence alignment.

57. The method of claim 55, comprising identifying the evolutionary constraints with calibration of cutoff.

58. The method of claim 55, further comprising identifying weighted distance constraints (e.g., using Haddock/CNS).

59. The method of claim 55, further comprising identifying all-atom coordinates of the polypeptide complex.

60. The method of claim 55, further comprising evaluating prediction accuracy.
